(19) United States
(12) Patent Application Publication
(10) Pub. No.: US 2003/0194366 A1
(43) Pub. Date: Oct. 16, 2003

(54) Catalysts and process for oxidizing hydrogen sulfide to sulfur dioxide and sulfur

(76) Inventors: Girish Srinivas, Thornton, CO (US); Steven Charles Gebhard, Golden, CO (US); Michael E. Karpuk, Boulder, CO (US)

Correspondence Address: GREENLEE WINNER AND SULLIVAN P C, 5370 MANHATTAN CIRCLE, SUITE 201, BOULDER, CO, 80303, US

(21) Appl. No.: 10/358,404

(22) Filed: Feb. 3, 2003

Related U.S. Application Data
(60) Provisional application No. 60/367,891, filed on Mar. 25, 2002.
(60) Provisional application No. 60/388,322, filed on Jun. 13, 2002.
(60) Provisional application No. 60/420,694, filed on Oct. 22, 2002.

(51) Int. Cl. B01D 50/00; B01D 53/52

(52) U.S. Cl. 423/230; 422/177; 422/168; 422/211; 422/234; 423/573.1

(57) ABSTRACT

The invention relates to catalysts and catalytic methods for selective oxidation of hydrogen sulfide (H₂S) in a gas stream containing one or more oxidizable components other than H₂S to generate sulfur dioxide (SO₂), elemental sulfur (S) or both without substantial oxidation of the one or more oxidizable components other than H₂S. The catalysts and methods herein are useful, for example, for the selective oxidation of H₂S to SO₂, sulfur or both in the presence of hydrocarbons, hydrocarbon oxygenate, sulfur-containing organic compounds, aromatic hydrocarbons, aliphatic hydrocarbons, carbon dioxide, hydrogen or carbon monoxide.

### CROSS-REFERENCE TO RELATED APPLICATIONS

This application takes priority under 35 U.S.C. 119(e) from U.S. provisional applications Nos. 60/367,891, filed Mar. 25, 2002; 60/388,322, filed Jun. 13, 2002; and 60/420,694, filed Oct. 22, 2002, all of which are incorporated in their entirety by reference herein.

### REFERENCE TO GOVERNMENT FUNDING

The work leading to this invention was funded at least in part by the United States Government through Department of Energy grant Nos. DE-FC26-99FT40725 and DE-FC26-99FT40497. The United States Government has certain rights in this invention.

### BACKGROUND OF THE INVENTION

The implementation of stricter emission limits for hydrogen sulfide (H₂S) and sulfur dioxide (SO₂) has stimulated the development and improvement of processes for the desulfurization of natural gas, synthesis gas, gasification streams and other gas streams used or generated in petroleum processing, oil recovery and coal utilization. For example, the level of H₂S in natural gas must be lowered to 4 ppmv to meet pipeline specifications. Sulfur removal or desulfurization processes can also be applied to offgas generated in digesters or in waste water treatment, or to geothermal gases

Different chemical and biological processes are used for H₂S removal (and removal of other sulfur-containing gases) from gas streams depending on the scale of the application. (McIntush et al.2001.) Small-scale removal (˜less than 0.1 long tons/day (LTPD) employs scavenging chemicals which are typically nonregenerable (Fisher et al. 1999). Medium-scale removal (between about 0.1-30 LTPD) has employed various processes, biological treatment, liquid redox processes and liquid Claus processes. Large-scale removal has employed Claus processes (which may be combined with amine pretreatment and/or Claus Tail Gas Treatment, CTGT.) In medium- and large-scale desulfurization of gas streams, sulfur-containing components are converted (in one or more steps) to elemental sulfur which can be removed from the gas stream.

Claus plants (as illustrated in FIG. 1, Prior Art) are typically used when large quantities of sulfur are to be recovered (>10 ton/day). These systems can have multiple Claus catalyst beds (109a-c) and multiple sulfur condensers (114a-d). Also, the process stream being desulfurized (entering at 103) is often initially treated by an amine unit (not shown in FIG. 1) to separate the H₂S and concentrate it prior to processing in the Claus plant. In the amine unit, H₂S dissolves into and reacts with an amine solution. When the amine solution is regenerated, the liberated H₂S is sent to the Claus plant to convert the H₂S into elemental sulfur. When the H₂S content of the gas is greater than about 40%, the gas, after addition of air, first passes into a furnace (120) where (ideally) ⅓ of the H₂S is combusted into SO₂ (see Equation 1). A considerable amount of elemental sulfur is generated in the furnace (collected in a first condenser 114a) by partial oxidization of H₂S (Equation 2) and by gas phase Claus reaction (Equation 3).

$${H}_{2} S + \frac{3}{2} {O}_{2} -> {H}_{2} O + {SO}_{2} . \qquad Equation 1$$

Oxidation of H₂S into SO₂

$${H}_{2} S + \frac{1}{2} {O}_{2} -> {H}_{2} O + S . \qquad Equation 2$$

Partial oxidation of H₂S into water and elemental sulfur.

2H₂S+SO₂₌2H₂O+3S Equation 3.

Claus equilibrium reaction.

Table 1 shows the Claus processing configurations used as a function of H₂S concentration in the feed gas.

TABLE 1
Claus Processing as a Function of H₂S Concentration in Feed

| H₂S in feed (%) | Type of Claus Unit |
|---|---|
| 55-100 | Straight through |
| 40-55 | Straight through with feed and/or air preheat |
| 25-40 | Split flow |
| 12-25 | Split flow with feed and/or air preheat |
| 7-12 | Split flow with feed and/or air preheat with added |
| | fuel |
| <7 | Claus not practical |
| | Source: “Look at Claus Unit Design” Alcoa |
| | Technical Bulletin (1997) |

When the H₂S content is low (<40%) or very low (<20%) then the split Claus process is used (illustrated in FIG. 1, dashed line, 104). The split flow is used because the H₂S concentrations are too low for stable combustion at the required flame temperature of about 1700° F. By splitting off up to ⅓ of the gas and burning the H₂S to completion (SO₂) the necessary flame temperature can be sustained. All of the H₂S in the split stream exiting the furnace has been oxidized to SO₂ which when remixed with the remaining ⅔ of the flow gives the 2:1 H₂S/SO₂ ratio needed in the Claus converters (Kohl and Nielsen 1997). To meet emissions requirements, Claus tail gases (exiting at 111) must often be treated to remove residual H₂S.

One often-employed tail gas treatment is the SCOT™ process (Shell Claus Off-Gas Treatment, Goar and Sames 1983.) Modified Claus processes, such as the SuperClaus™ (U.S Pat. No. 5,352,422) and the EuroClaus process (Nagl, 2001) employ special catalysts in the last Claus stage to improve efficiency and decrease emissions. See, U.S. EPA Background Report AP-42 Section 5.18 “Sulfur Recovery” (1996) prepared by Pacific Environmental Services, Inc. for a description of the Claus Process and various Claus tail gas treatments.

Claus plants are uneconomical for small-scale sulfur recovery. Liquid redox processes are more commonly used for small-scale (ca. 0.2-10 ton/day) sulfur recovery operations.

Liquid redox sulfur recovery processes are extremely efficient, removing over 99% of the sulfur in the feed. Two examples are the LO-CAT(LO-CAT II) process (shown in FIG. 2, Prior Art) and the SulFerox™ process which are based on a liquid redox system employing a chelated iron solution (Kohl and Nielsen 1997; Hardison and Ramshaw 1992; Smit and Heyman 1999; Oostwouder 1997). In this process, the H₂S containing gas stream (inlet 203) is contacted with the chelated Fe³⁺ complex in solution (in absorber 250). The H₂S dissolves in the solution forming hydrosulfide ions (HS⁻) that reduce Fe³⁺ to Fe²⁺ and generate elemental sulfur according to the Equation 4:

2Fe³⁺+HS⁻→2Fe²⁺+S+H⁺ Equation 4:

Oxidation of Hydrosulfide Ions in LO-CAT

The solution is then regenerated (in oxidizer 260) with air (inlets 270) oxidizing the Fe²⁺ to the original Fe³⁺ to complete the catalytic cycle:

$$\begin{matrix}Equation 5 : Regeneration of Iron Catalyst \\ 2 {Fe}^{2 +} + \frac{1}{2} {O}_{2} + {H}_{2} O -> 2 {Fe}^{3 +} + 2 {OH}^{-}\end{matrix}$$

Regeneration of Iron Catalyst

Both reactions take place at about 50° C. The sulfur is generally removed as froth (via 290) from the oxidizer (260) and depending on the quantity and quality of the sulfur is either sold as a commodity chemical or sent to disposal. Regenerated solution is returned to the absorber (250). Desulfurized gas exits (211) the absorber. The effluent air from the LO-CAT oxidizer is generally free of sulfur compounds and is either vented directly to the atmosphere or sent to an incineration unit prior to venting.

Although liquid redox processes can recover more than 99% of the H₂S in small-scale gas treatment plants, they have some limitations. A major concern is high chemical costs for make-up and catalyst replacement. Also, gas/liquid mass transfer limitations are significant, requiring the use of large vessels, which increases capital costs. The formation of thiosulfate, HCN, bacterial growth, and thermal instability can be troublesome in LO-CAT and must be suppressed. For example, in the LO-CAT process, SO₂ cannot be tolerated in high concentrations because it makes the aqueous phase too acidic, which increases the tendency to form thiosulfate.

Most liquid redox systems use air (oxygen) to oxidize the H₂S. In a second type of liquid redox sulfur recovery processes, H₂S is reacted with SO₂ in solution (liquid phase Claus) and the sulfur produced by the reaction is removed by crystallization. In an exemplary, non-aqueous liquid Claus process, the Crystasulf^{SM} process (see U.S. Pat Nos. 5,733,516 and 5,738,834) H₂S is reacted with SO₂ in a non-aqueous solution and the sulfur produced by the reaction is crystallized out of solution, as illustrated in FIG. 3 (Prior Art). See also Mclntush et al. 2000 and C. Rueter 2002.) As illustrated, sour gas (containing H₂S and other sulfur compounds) is introduced into the system (inlet 303) to absorber 350 containing the non-aqueous solution. Sulfur produced by reaction in the absorber unit is removed from the non-aqueous solvent by crystallization in a crystallizer unit 320 followed by sulfur filtration 317. Sweet gas with decreased sulfur content exits (311).

These systems typically require an external source of SO₂ to obtain the proper H₂S to SO₂ stoichiometric ratio (of 2:1) for reaction in the Crystasulf^{SM} process. While it is reported that the Crystasulf^{SM} process can be operated off-stoichiometry for a significant period of time without loss of removal efficiency (Rueter, 2002), it is nevertheless preferred and more efficient overall to operate the process at (or close to) the proper H₂S/SO₂ stoichiometry. Depending on the scale of the process, liquid SO₂ can be added, product sulfur may be burned to generate SO₂, or a portion of the H₂S feed can be oxidized to generate SO₂ for the redox process. Liquid SO₂ is expensive and its use is economical only for small-scale applications. The use of an elemental sulfur burner upstream of the liquid redox process is also expensive, adds operational complexity to the overall process, and increases the sulfur load on the liquid redox unit (e.g., a Crystasulf^{SM} unit). The sulfur load is increased because the SO₂ that comes from the external source also has to be recovered as elemental sulfur. Consequently, with an external SO₂ source the size of the liquid redox unit has to be increased to accommodate the additional sulfur load.

U.S. Pat. No. 6,416,729 (DeBerry et al.) relates to a process for removal of H₂S from gas streams using a non-aqueous scrubbing liquor, such as a Crystasulf^{SM} process, in which H₂S and dissolved sulfur react to form nonvolatile polysulfides. In this process, SO₂ added to the liquor is reported to act as an oxidizing agent to convert the nonvolatile polysulfide to sulfur. Sulfur is removed from the liquor by crystallization. The patent indicates that SO₂ can be added to the feed gas entering the absorber unit by use of a gas stream already containing SO₂, addition of external SO₂ (liquid SO₂ pumped from an SO₂ cylinder) and the use of a full or partial oxidation catalyst upstream of the absorber to convert H₂S to SO₂ (or to SO₂ and S.) Desulfurization processes that rely on a biological transformation (employing microorganisms) of sulfide to sulfur or of sulfite via sulfide to sulfur are employed commercially. H₂S, first converted to sulfide, can, for example, be directly converted to sulfur by sulfur bacteria, e.g., Thiobacilli. SO₂, first converted to sulfite, can, for example, be reduced to sulfide in an anaerobic reactor in the presence of microorganisms and hydrogen and the sulfide can then be oxidized to sulfur in an aerobic reactor in the presence of microorganisms (Janssen 2001). Exemplary commercial processes are those marketed as the Shell-Paques/THIOPAQ processes or as the Thiopaq DeSOₓ process.

Desulfurization is often required for applications other than natural gas, including purification of gasification streams, associated gas from wells, and various gas streams generated in petroleum refining.

Hydrogen and CO are the products of the gasification of coal, hydrocarbons, biomass, solid waste and other feedstocks. Gasification is most generally any process where carbon-containing materials are converted into product gases containing primarily carbon monoxide (CO) and hydrogen (H₂). Various gasification processes are known and practiced in the art.

The product gas generated by gasification can be used to generate electricity or steam or can be used in chemical synthesis to make methyl alcohol (methanol), higher alcohols, aldehydes, or synthetic fuels (via Fischer Tropsch catalysis). Because one of the uses of gasifier product gas is to make chemicals, it is frequently referred to as synthesis gas or syngas (Satterfield 1991). In most gasification processes, sulfur compounds present in the feedstock are converted into hydrogen sulfide, which appears in the product gas. Hydrogen sulfide must be removed from the CO and H₂ mixture before the gas can be used for power generation because burning it generates sulfur dioxide emissions from the power plant. Hydrogen sulfide must be removed from the CO and H₂ used for chemical synthesis because H₂S irreversibly damages the catalysts used to make alcohols, aldehydes, and other products.

Conventional (low temperature) synthesis gas cleanup to remove hydrogen sulfide involves cooling the synthesis gas and scrubbing it with an amine solution to absorb the H₂S (Kohl and Nielsen 1997). The H₂S-free gas then has to be reheated for used in power generation or chemical synthesis. A process in which H₂S could be efficiently removed directly in a one step process from synthesis gas without the need to cool the gas would significantly improve the economics of synthesis gas use for both power generation and chemical synthesis.

The present invention relates to improved methods for H₂S removal from gas streams. The method relies at least in part on selective direct oxidation of H₂S employing certain mixed metal oxide catalysts. The oxidization is selective for H₂S oxidation in the presence of other oxidizable species including hydrocarbon species. Various catalysts for the oxidation of H₂S to SO₂ and H₂S to elemental sulfur are known in the art.

Common oxidation catalysts such as Pt/Al₂O₃ or Pd/Al₂O₃ are not good H₂S oxidation catalysts because they are rapidly and irreversibly poisoned by the presence of even small quantities of H₂S (the metal sulfides are very stable). Metal oxide catalysts on the other hand tolerate sulfur compounds quite well and several are excellent catalysts that can oxidize H₂S into elemental sulfur, SO₂ and even SO₃.

A comparison of a wide variety of transition metal oxides (TMO) was made by Marshneva and Mokrinskii (1989). TMOs were purchased or prepared by precipitation of the corresponding hydroxides (followed by calcining), or by calcining the transition metal carbonates. Rates of reaction were measured for the partial oxidation of H₂S, the deep oxidation to form SO₂ and the Claus reaction. Unfortunately, the oxides exhibited a wide range of surface areas and it is not clear from the data provided whether an oxide that performed poorly in one reaction might perform better if prepared differently because of the possibility of exposing different or additional catalytic sites. Nevertheless, Marshneva and Mokrinskii found that the catalyst activity for the Claus reaction could be ranked as: V₂O₅>>TiO₂>Mn₂O₃>La₂O₃>CaO>MgO>Al₂O₃>ZrO₂>Cr₂O₃>>SiO₂. The catalyst activity ranking for the H₂S partial oxidation catalysis was V₂O₅>Mn₂O₃>CoO>TiO₂>Fe₂O₃>Bi₂O₃>Sb₂O₅>CuO>Al₂O₃═MgO═Cr₂O₃. V₂O₅ was, by a large margin, the most active catalyst, with Bi₂O₃ a distant second. The next most active catalyst is Fe₂O₃ (which is contained in the catalyst (Fe₂O₃/SiO₂/Al₂O₃) used in the SuperClaus process, see U.S. Pat. No. 5,352,422).

Various patents relate to the oxidation of H₂S and other sulfur compounds to SO₂. For example, the use of group VIIIA metal oxides as the active materials for the oxidation of H₂S into elemental sulfur has been reported (U.S. Pat. Nos. 6,299,851; 6,251,359; 5,653,953; 6,083,473; and 6,207,127). U.S. Pat. No. 6,299,851 reports the use of a vanadium-containing material and a catalytic substance selected from Sc, Y, La and Sm and optionally an antimony-containing promoter for oxidation of H₂S. U.S. Pat. No. 6,251,359 reports selective oxidation of H₂S to sulfur using a multi-component catalyst containing antimony, vanadium and magnesium materials. U.S. Pat. No. 5,653953 relates to selective oxidation of H₂S using a mixed metal catalyst containing vanadium in combination with molybdenum or magnesium. U.S. Pat. No. 6,083,473 relates to catalysts for selective oxidation using a Group VIIIA metal oxide supported on a laminar phyllosilicate alone or in combination with silica or alumina. U.S. Pat. No. 6,207,127 relates to a method for oxidizing H₂S to sulfur using a catalyst which is an iron and zinc oxide supported on silica.

SO₂ production is reported in several patents (U.S. Pat. Nos. 4,314,983; 4,088,743; 4,427,576 and 4,012,486). Several journal articles relate to oxidation of H₂S (Nivak and Zdrazil 1991; Mirzoev, I. M. 1991). U.S. Pat. Nos. 4,314,983; and 4,088,743 report catalysts containing both bismuth and vanadium oxides and V₂O₅ supported on acidic mordenite or Al₂O₃ for H₂S oxidation. These patents report oxidizing H₂S in streams that contain H₂, CO, ammonia and light hydrocarbons. Hydrogen sulfide is oxidized, but the light hydrocarbons are not. The primary application of the reported catalytic technology is to treat waste gas streams from geothermal steam power plants, hence the catalysts are made to be stable in gases that have a water partial pressure of at least 1.5 psia. The catalyst reported was not designed to operate in natural gas streams where the hydrocarbon content can approach 95 vol % and where BTEX (benzene, toluene, ethylbenzene and xylene) and other heavy hydrocarbons may be present. U.S. Pat. No. 4,012,486 reports oxidation of H₂S to SO₂ using bismuth oxide supported on Al₂O₃.

U.S. Pat. No. 4,427,576 reports a catalyst supported on TiO₂ for simultaneously oxidizing H₂S, COS and CS₂ into SO₂ and a method for making the catalyst. The catalytically active components on the TiO₂ were chosen from Mo, Ni, Mn, V, and Cr oxides. All of the catalysts described in the patent were synthesized using the incipient wetness impregnation method.

U.S. Pat. Nos. 4,243,647 and 4,311,683 report the use of a vanadium oxide or sulfide catalyst supported on a non-alkaline porous refractory oxide for oxidation of H₂S to elemental sulfur. The catalyst is reported not to oxidize H₂, CO or light hydrocarbons in the treated gas streams. SO₂ is not reported to be produced by this catalytic oxidation reaction. Further, it is reported that gas streams in which the ratio of SO₂ to H₂S is greater than 0.5 should be passed through a hydrogenation process to generate H₂S from the SO₂ present before passage through the H₂S oxidation reactor.

U.S. Pat. Nos. 4,857,297; and 4,552,746 relate to TiO₂ catalysts for generating sulfur from H₂S. The catalyst is reported to consist essentially of TiO₂ and to preferably contain at least about 80% by weight TiO₂. The catalyst is reported not to oxidize light saturated hydrocarbons, CO or H₂ present in gas streams. It is also reported that the O₂ level in the reaction can be adjusted to produce a product gas containing low levels of a 2:1 mixture of H₂S:SO₂ for subsequent introduction into a Claus reactor. The highest level of the mixture exemplified was a product gas containing 0.28% H₂S and 0.14% SO₂.

U.S. Pat. No. 4,623,533 reports a TiO₂-supported catalyst for direct oxidation of H₂S to sulfur. The catalyst is reported to contain from 0.1 to 25% by weight nickel oxide and from 0 to 10% by weight aluminum oxide (where the percentages are based on the supported catalyst).

U.S. Pat. No. 6,099,819 reports certain mixed metal oxide catalysts containing titania for the partial oxidation of H₂S to elemental sulfur.

While a number of catalysts have been reported for use in desulfurization processes, there remains a need in the art for improved high efficiency and lower cost desulfurization processes. In particular there remains a need for catalysts for conversion of H₂S to SO₂, sulfur or both, that are resistant to deactivation in the presence of hydrocarbons (saturated and aromatic) and which are useful for desulfurization of gas streams containing higher levels (10% by volume or more) of CO and H₂.

### SUMMARY OF THE INVENTION

The invention relates to catalysts and catalytic methods for selective oxidation of hydrogen sulfide (H₂S) in a gas stream containing one or more oxidizable components other than H₂S to generate sulfur dioxide (SO₂), elemental sulfur (S) or both without substantial oxidation of the one or more oxidizable components other than H₂S. The catalysts and methods herein are useful, for example, for the selective oxidation of H₂S to SO₂, sulfur or both in the presence of hydrocarbons, hydrocarbon oxygenate, sulfated hydrocarbons, aromatic hydrocarbons, aliphatic hydrocarbons, carbon dioxide, hydrogen or carbon monoxide. The catalysts and methods herein are particularly useful for the selective oxidation of H₂S in gas streams containing natural gas (substantially methane), in gas streams containing one or more low molecular weight volatile hydrocarbons (methane, ethane, propane, butane, etc.), in gas streams containing one or more natural gas liquids (NGLs, e.g., pentanes (C5)-nonanes (C9)), in gas streams containing aromatic hydrocarbons, such as benzene, toluene, ethylbenzene and xylene (BTEX) and in gas streams, particularly synthesis gas streams, containing carbon monoxide and hydrogen.

Preferred catalysts and methods of this invention are those that function in gas streams containing relatively high levels of light hydrocarbons, for example, for use in gas streams containing 50% or more by volume of methane or in methane rich gas containing 90% volume or more methane, without substantial oxidation of the hydrocarbon. Preferred catalysts and methods of this invention function for desulfurization of natural gas streams containing low molecular weight hydrocarbons other than methane (ethane, propanes, butanes, heptanes, hexanes, etc.) without substantial oxidation of the hydrocarbons. Preferred catalysts and methods of this invention function for desulfurization in natural gas streams containing aromatic species, such as BTEX without substantial oxidation of the aromatic species.

In general, in the methods of this invention a gas stream containing H₂S and other oxidizable components is contacted with a mixed metal oxide oxidation catalyst at a temperature less than or equal to about 500° C. in the presence of a selected amount of oxygen to generate SO₂, sulfur or both wherein less than about 25 mol % by volume of the oxidizable components other than H₂S and other sulfur-containing compounds are oxidized by the oxygen. In preferred methods less than about 10 mol % by volume of the oxidizable compounds other than H₂S and other sulfur-containing species are oxidized by the oxygen. In more preferred methods less than about 1 mol % volume of the oxidizable compounds other than H₂S and other sulfur-containing species are oxidized by the oxygen. Gas streams may contain other sulfur-containing species which are either oxidized directly, or are first converted to H₂S which is thereafter oxidized to generate SO₂, sulfur or both. Sulfur-containing species that may be present in gas streams include, among others, H₂S, SO₂, CS_{2,}, COS, and mercaptans.

The catalysts of this invention are mixed metal oxides comprising a low oxidation activity metal oxide selected from the group of titania, zirconia, silica, alumina or mixtures thereof in combination with one, two, three, four or more metal oxides having a higher oxidation activity compared to the low oxidation activity metal oxide. The higher oxidation activity metal oxides can be transition metal oxides, lanthanide metal oxides or both selected from oxides of V, Cr, Mn, Fe, Co, Ni, Cu, Nb, Mo, Tc, Ru, Rh, Pd, Hf, Ta, W, Re, Os, Ir, Pt, Au, La, Ce, Pr, Nd, Pm, Sm, Eu, Gd, Tb, Dy, Ho, Er, Tm, Yb, Lu, or mixtures thereof. Preferred high oxidation activity transition metal oxides are those that are oxides of V, Cr, Mn, Fe, Co, Ni, Cu, Nb, Mo, W, and mixtures thereof. Preferred high oxidation activity lanthanide metal oxide is that of La. More preferred higher oxidation activity metal oxides are oxides of V, Cr, Mn, Fe, Co, Ni, Cu, Nb, Mo, or mixtures thereof. Yet more preferred higher oxidation activity metal oxides are oxides of Nb, Mo, Cr, Mn, Fe, Co or Cu. Preferred mixed oxide catalysts of this invention comprise two, three or four high oxidation activity metal oxides.

In specific embodiments catalysts of this invention include: mixtures of molybdenum oxide and titania, mixtures of niobium oxide and titania, mixtures of molybdenum oxide, niobium oxide and titania, and mixtures of molybdenum oxide, iron oxide and titania.

Selectivity of the methods and catalysts of this invention is at least in part controlled by use of temperatures less than or equal to about 500° C. Decreasing the temperature at which the catalytic oxidation of H₂S occurs generally minimizes the oxidation of oxidizable components other than H₂S and sulfur. The temperature of the reactor should, however, be maintained above the dew point of sulfur, for given process conditions, so that sulfur does not condense onto the catalyst or in the catalytic reactor system. The temperature should also be maintained sufficiently high to obtain good catalyst efficiency (measured as % conversion of H₂S present).

Good catalyst efficiency means that 50% of more of the H₂S is converted to SO₂, sulfur or both. Preferably the catalyst and other conditions are selected to achieve 85% efficiency or more for conversion of H₂S into SO₂, sulfur or both. More preferably 95% or more efficiency of conversion of H₂S is achieved and most preferably 99% or more efficiency of conversion is achieved. Preferred high efficiency catalysts also exhibit long lifetimes being resistant to catalyst deactivation in the presence of oxidizable species other than H₂S, to deactivation by other sulfur containing species or to water vapor. In specific embodiments the catalytic reaction is conducted at temperatures between about 100° C. and about 400° C. Improved selectivity of oxidation of H₂S and at least good efficiency of conversion of H₂S can be obtained when the temperature at which the catalytic reaction is conducted is below about 350° C. The reaction temperature is preferably maintained above about 160° C. for satisfactory catalytic activity. In preferred methods of this invention the catalytic reaction is conducted at temperatures ranging from about 160° C. to about 250° C. In more preferred methods of this invention the catalytic reaction is conducted at temperatures ranging from about 170° C. to about 200° C.

The amount of oxygen present during the reaction can be adjusted to affect the efficiency of oxidation of H₂S and the relative amounts of SO₂ and sulfur generated on oxidation of H₂S. In principle, sufficient oxygen may be present in a gas stream to allow a desired level of oxidation of H₂S and the generation of the desired ratio of SO₂ to sulfur. Most often, however, oxygen, typically added as air, will be added to the gas stream to adjust the ratio of O₂ to H₂S in the gas stream. The amount of oxygen in the gas stream to be contacted with the catalysts of this invention depends on the amount of H₂S present and generally is adjusted to obtain a selected ratio of O₂ to H₂S. This ratio can be adjusted widely from about 0.1 to greater than 10, but a typically useful range is between about 0.4 to about 5. More typically the oxygen is adjusted so that the O₂ to H₂S ratio is within a range from about 0.4 to about 1.75. In some case, excess oxygen, where the O₂ to H₂S ratio is greater than 1.75 may be desirable. Where partial oxidation products, e.g., higher amounts of sulfur compared to SO₂ are desired, lower ratios of O₂ to H₂S are used (about 0.4 to about 1.0 or less than 0.5). Where higher amounts of SO₂ are desired, higher ratios of O₂ to H₂S (about 1.0 to 1.75 or greater than about 1.75) can be used.

The invention relates to a heterogeneous catalyst and a catalytic process that can be used to oxidize hydrogen sulfide (H₂S) into elemental sulfur, sulfur dioxide (SO₂) gas or a mixture of thereof with the selectivity to each product determined by the amount of oxygen present (more specifically the O₂/H₂S ratio), the temperature selected, and variations in catalyst composition. The catalyst and process can be used to generate SO₂ and sulfur for any process, but is particularly useful for applications to liquid phase sulfur recovery and to desulfurization processes. The catalyst and process can be used to oxidize H₂S into sulfur, for example, for use upstream of liquid redox sulfur recovery systems such as the LO-CAT processes or the SulFerox process, or can be used to oxidize H₂S into SO₂, for example, for feeding a mixture of H₂S and SO₂ to liquid phase Claus sulfur recovery systems, such as the Crystasulf^{SM} non-aqueous liquid phase Claus process, and for feeding into conventional Claus units. In the latter application, the catalytic reactor can preferably be used as a replacement for the Claus furnace in a Split Flow Claus Process. The preferred ratio of H₂S to SO₂ for a Claus process is 2:1. The catalytic reactor of this invention can provide this ratio. However, the reactor can be operated to provide a range of ratios of H₂S to SO₂ (e.g., about 1:1 to about 3:1 ) which can be processed in a Claus reactor. The catalyst and process can also be used to oxidize H₂S into sulfur, for example, for use upstream of biological treatment processes such as Shell-Paques process, scavenger processes, or amine acid gas separation processes.

The catalysts and methods of this invention can be used to desulfurize gases containing CO and hydrogen, particularly those gases that are categorized as synthesis gas. The catalyst and methods of this invention are useful for desulfurization of synthesis or gasification gas streams containing about 1% by volume or more of CO, H₂, or both, are useful for desulfurization of gas streams containing about 10% by volume or more of CO, H₂, or both, and are useful for desulfurization of gas streams containing about 30% by volume of CO, H₂, or both.. Additionally, the catalyst and methods of this invention are useful for desulfurization of synthesis or gasification gas streams containing from 1%-10% by volume, 2% to 10% by volume or 2% by volume or more of CO, H₂ or both. In this application, preferred desulfurization catalysts minimally oxidize (oxidize less than about 5% by volume of and more preferably less than about 2% by volume of) the CO and H₂ components of the gas stream.

The catalysts and methods of this invention will also oxidize H₂S into SO₂ (and/or sulfur, dependent upon the amount of oxygen present) when the H₂S is present in natural gas without any substantial oxidation of any of the hydrocarbons present in the natural gas. This permits direct removal of H₂S from natural gas without the use of amine pretreatment. The catalyst will oxidize H₂S into SO₂ (and/or sulfur) in the presence of saturated hydrocarbons, as well as, aromatic hydrocarbons, specifically BTEX components.

The catalysts and methods of this invention can also be used to decrease the levels of mercaptans in gas streams.

The catalysts of this invention have been operated for the oxidation of H₂S into SO₂ using dry feed, humidified feed, and feed containing hydrocarbons (saturated and aromatic). Methane and other alkanes are inert during H₂S oxidation over these catalysts under the conditions employed, and consequently, H₂S can be oxidized into SO₂ in-situ in natural gas streams.

An exemplary catalyst of this invention has been tested for over 1300 hours of operation for oxidation of H₂S into sulfur (at pressures ranging from 1-5 psi and at a temperature near 190° C.), without degradation of activity or selectivity. This catalyst exhibited H₂S conversion in excess of 85 mol % with over 99% selectivity to sulfur. Tests conducted in which the gas stream (e.g., process gas feed) contained 10% methane (CH₄), 500 ppm of n-hexane (C₆H₁₄), 4400 ppm of toluene and 4000 ppm of xylene in the gas stream demonstrate that these hydrocarbons passed through the reactor substantially without being oxidized and without deactivating or otherwise degrading the performance of the catalyst.

Hydrogen sulfide oxidation of this invention can be carried out between ambient pressure and about 1000 psig in the presence of hydrocarbons, CO, hydrogen, CO₂ or water vapor. More typically, the operating pressure of the reaction can be up to about 500 psig. The maximum allowable operating pressure is determined by the dew point pressures of elemental sulfur, water and hydrocarbons in the system so as to avoid condensation of these components into the liquid phase. This maximum allowable pressure depends on the composition of the gas entering the process and the temperature at which the catalytic reaction is operated.

The catalytic H₂S oxidation technology of this invention can provide a source of SO₂, for sulfur recovery processes (Claus processes) eliminating the need for either shipping in liquid or compressed SO₂ from an external source, or installing a sulfur burner system upstream of a liquid-phase or conventional Claus sulfur recovery plant. This lowers capital and operating costs of the plant by simplifying the process and decreasing the size of the unit compared to the case where extra SO₂ is added either as gas, liquid or from sulfur burning. The size of the plant unit is reduced because the use of any of the conventional methods of supplying the necessary SO₂ increases the total amount of sulfur (sulfur load) that must be processed. The inventive process is also useful in any process where SO₂ is required and a source of H₂S is available.

The inventive process and catalyst can also be used to reduce the sulfur burden of downstream high-efficiency sulfur recovery processes, such as LO-CAT and SulFerox. By controlling the catalyst operating temperature and the amount of O₂ added as air, the composition of the product gas from the inventive process can be adjusted so the recovery of elemental sulfur is high and the concentration of SO₂ is very low. This is done by decreasing the amount of O₂ and operating at relatively low temperatures Oust above the sulfur dew point) so that some of the H₂S remains unconverted. This gas stream (now with a lower H₂S concentration) is then processed in the sulfur recovery unit

The inventive process can also specifically be used to replace the furnace of a Split-Flow Claus unit for processing low concentrations of H₂S. For gases with H₂S concentrations below about 40%, it is difficult to obtain stable combustion, if the entire gas stream is to be burned to obtain the correct H₂S to SO₂ ratio. The conventional solution to this problem has been to bypass up to ⅓ of the gas and burn all of the H₂S in that stream to SO₂ and to then remix the SO₂ stream with the remaining ⅔ gas stream contain unconverted H₂S before entering the first catalytic Claus stage. The inventive process can be used to generate the required SO₂ for the Split-Flow Claus process. By controlling the amount of air added to the direct oxidation catalytic reactor of this invention and operating at moderate temperatures (approximately 200° C.), H₂S can be converted in the split stream into SO₂ and elemental sulfur.

In another specific embodiment, the catalytic direct oxidation reactions of this invention can be combined upstream of art-known Claus Tail Gas Treatments, such as the SCOT process (particularly for medium-scale sulfur removal) or upstream of art-known scavenging chemicals (particularly for small-scale or medium scale sulfur removal).

In further specific embodiments, the catalytic direct oxidation reactions of this invention can be combined with biological sulfur removal processes such as the Shell-Paques, the THIOPAQ process or the Thiopaq DeSOₓ process. The catalytic process of this invention can, for example, be employed to maximize sulfur production and removal from a gas stream with residual H₂S, SO₂ or mixtures thereof passed into directly or indirectly into appropriate aerobic and/or anaerobic biological reactors (containing selected microorganisms for conversion of sulfide and/or sulfite to elemental sulfur).

In another specific embodiment, the catalytic direct oxidation reactions of this invention can be combined with acid gas recycling to generate gas streams that are appropriate for pipeline specifications. Sulfur remaining in a gas stream after application of the direct oxidation can be separated from that gas stream and the treated gas stream is recycled back to the direct oxidation unit. This recycling can be performed continuously or as needed to achieve a desired level of sulfur removal. In general any process that can separate acid gases from the gas stream (e.g., that can separate H₂S and/or SO₂ from the gas stream) can be employed for recycling. More specifically, an amine unit, which captures and separates acid gases can be employed. A variety of amine units are known in the art which employ various amine compounds for capture of the acid gases. Any amine unit appropriate for the use with a given gas source can be applied in combination with the direct oxidation of this invention. Those of ordinary skill in the art can readily select an amine unit or other device or system for separation of H₂S and/or SO₂ appropriate for combination with the direct oxidation of this invention and for use with a given gas source.

In another specific embodiment, the invention provides methods and catalysts for converting hydrogen sulfide into SO₂, elemental sulfur or both in a feed gas stream containing carbon monoxide (CO), hydrogen (H₂) and hydrogen sulfide. The method and catalysts of this invention selectively oxidize hydrogen sulfide in such feed streams preferably without any substantial oxidation of carbon monoxide or hydrogen. For example, the methods and catalysts of this invention can be used to obtain high efficiency conversion of H₂S with substantially no oxidation of CO and hydrogen (e.g., such that less than about 10% by volume of the CO and hydrogen are oxidized).

Elemental sulfur removed in the processes of this invention will as is known in the art vary in purify dependent upon the processes used to generate it. Recovered sulfur may be sufficiently pure for agricultural or industrial application or may require additional washing, melting or other purification steps to render it useful for such applications.

The catalysts of this invention can, for example, be employed in the form of particles, pellets, extrudates (of varying sizes) or the like in fixed bed reactors and/or fluidized bed reactors. Catalyst form and size are selected as is known in the art for a given reactor type and reaction conditions. Catalyst reactors employed in the process of this invention may be provided with internal temperature control and/or heat removal systems, particularly where gas streams having higher concentrations of H₂S (>1-2%) are to be treated. Catalytic oxidation processes of this invention can generally be run with space velocity between about 100 and about 20,000 m³ of gas/m³ of catalyst/hour. Alternatively the space velocity can be between about 500 and about 10,000 m³ of gas/m³ of catalyst/hour or between about 1,000 to about 5,000 m³ of gas/m³ of catalyst/hour. The catalysts of this invention can be employed in any catalytic reactor design known in the art appropriate for the pressure and temperature conditions of the reaction and appropriate for receiving the gas stream (with any added air/oxygen and adapted for recycling of gases if desired) to be treated and the catalysts of this invention. Fixed and fluidized bed reactors can be employed, for example.

The invention also provides a catalytic reactor system for selectively oxidizing hydrogen sulfide in a gas stream containing hydrogen sulfide to sulfur dioxide, sulfur or mixtures thereof. The system includes a catalytic reactor containing a mixed metal oxide catalyst of this invention. and a sulfur condenser for removing sulfur produced in the catalytic reaction The entering gas stream containing hydrogen sulfide and optionally other sulfur-containing species is mixed with an oxygen-containing gas (e.g., air) and contacted with the catalyst in the catalytic reactor at a selected temperature. Sulfur is removed from the gas stream exiting the reactor by condensation in the condenser to produce a treated gas stream containing lower levels of sulfur-containing species than the entering gas stream. The catalytic reactor system can further be optionally equipped with a recycling system for directing at least a portion of the gas stream exiting the catalytic reactor back through the catalytic reactor (typically being mixed with the entering gas stream and the oxygen-containing gas) for removal of additional H₂S or other sulfur-containing species.

The treated gas may be released from the system if the levels of hydrogen sulfide or other sulfur-containing species are sufficiently low. Alternatively, the treated gas may be recycled or passed to downstream processing, for example, for additional treatment to further decrease the levels of hydrogen sulfide or other sulfur-containing species in the gas stream. The downstream processing can include processing in one or more sulfur-removal or recovery processes known in the art. Exemplary downstream processing include, but are not limited to:

treating the exiting gas stream with scavenging chemicals;

passing the exiting gas stream into a liquid phase redox sulfur removal system;

passing the exiting gas stream into a tail gas treatment system;

passing the exiting gas stream into a liquid Claus sulfur removal system; or

passing the exiting gas stream into a Claus reactor.

The catalytic reactor can optionally be equipped with a gas stream bypass for directing a portion of the entering gas stream directly to downstream processing. A gas stream bypass can be used, for example, to adjust the ratio of H₂S to SO₂ that enters downstream processing. A recycling system can also be combined with downstream processing wherein at least a portion of the gas stream exiting downstream processing is recycled through the system used for downstream processing or is recycled back through the catalytic reactor. Most preferably, the treated gas exiting the catalytic reactor system with optional downstream processing contains 4 ppmv or less of H₂S.

The invention is further illustrated by the following detailed description, the drawings and specific examples.

### BRIEF DESCRIPTION OF THE FIGURES

FIG. 1 is a schematic illustration of a prior art multistage Claus reactor for sulfur removal..

FIG. 2 is a schematic illustration of a prior art liquid redox sulfur removal process (LO-CAT).

FIG. 3 is a schematic illustration of a prior art liquid phase Claus process for sulfur removal (Crystasulf^{SM}).

FIG. 4 is a schematic illustration of a catalytic reactor configured for the direct oxidation reaction of this invention with a sulfur recovery condenser. The process is illustrated for syngas or natural gas treatment and has an optional liquid knock out device. Optional downstream processing or recycling of the gas stream exiting the reactor is indicated.

FIG. 5 is a schematic illustration of the catalytic reactor of this invention combined with a downstream amine unit (one exemplary downstream process) and configured for gas stream recycling.

FIG. 6 is a schematic illustration of an exemplary process configuration in which a catalytic reactor of this invention is positioned upstream of a liquid phase Claus process. The catalytic reactor is operated to generate a mixture of H₂S and SO₂, preferably with a H₂S and SO₂ of 2:1, for introduction into the liquid Claus reactor. An optional sour gas bypass is illustrated to facilitate adjustment of the H₂S and SO₂ as discussed in the specification.

FIG. 7 is a schematic illustration of an exemplary process configuration in which a catalytic reactor of this invention is positioned upstream of a liquid redox sulfur removal process. A LO-CAT process is exemplified.

FIG. 8 is a schematic illustration of an exemplary process configuration in which a catalytic reactor of this invention is positioned upstream of a biological sulfur removal process (Shell-Paques process is exemplified) in which sulfide is converted to sulfur for removal. The caustic scrubber in which H₂S is converted to sulfide as a part of the Shell-Paques process is not specifically shown.

FIG. 9 is a schematic illustration of an exemplary process configuration in which a catalytic reactor of this invention is positioned upstream of a conventional Claus unit (which may be a multi-stage Claus unit). The configuration illustrated is that of a Split-Flow Claus process in which the catalytic process of this invention replaces a furnace or burner (used in the prior art configuration to generated SO₂). Claus tail gas is illustrated as exiting the process. Art-known CTGT, such as the SCOT process, can be applied to treat the tail gas.

FIG. 10 is a schematic illustration of an exemplary process configuration in which a catalytic reactor of this invention is positioned upstream of a Claus Tail Gas Treatment (CTGT) unit. The unit is exemplified by a SCOT process with recycle.

FIG. 11. is a schematic illustration of the catalyst test apparatus.

FIG. 12 is a plot of H₂S conversion, selectivity to SO₂ and selectivity to elemental sulfur for a full factorial experimental design to measure the effects of O₂/H₂S and temperature on catalyst performance (see Example 2A).

### DETAILED DESCRIPTION OF THE INVENTION

The invention is based at least in part on the discovery of heterogeneous catalysts, more specifically mixed metal oxide catalysts, for selectively oxidizing H₂S into SO₂, elemental sulfur or both, but which do not effect the oxidization of other oxidizable species other than H₂S that may be present in gas stream from which H₂S and other sulfur containing compounds are to be removed.

Catalysts suitable for use in selective H₂S oxidation processes herein should:

exhibit low activity for hydrocarbon oxidation (e.g., paraffinic, olefinic and aromatic hydrocarbons);

resist deactivation by common natural gas contaminants (e.g., BTEX);

preferably give high conversions for H₂S oxidation (lowering the catalyst bed volume);

exhibit high selectivity for SO₂ under selected conditions; and

exhibit high selectivity for elemental sulfur under selected conditions.

The catalysts of this invention which have been found to exhibit the listed properties are mixed metal oxides comprising a low oxidation activity metal oxide selected from the group of titania, zirconia, silica, alumina or mixtures thereof in combination with one, two, three, four or more metal oxides having a higher oxidation activity compared to the low oxidation activity metal oxide. The higher oxidation activity metal oxides can be transition metal oxides, lanthanide metal oxides or both selected from oxides of V, Cr, Mn, Fe, Co, Ni, Cu, Nb, Mo, Tc, Ru, Rh, Pd, Hf, Ta, W, Re, Os, Ir, Pt, Au, La, Ce, Pr, Nd, Pm, Sm, Eu, Gd, Tb, Dy, Ho, Er, Tm, Yb, Lu, or mixtures thereof. Preferred high oxidation activity transition metal oxides are those that are oxides of V, Cr, Mn, Fe, Co, Ni, Cu, Nb, Mo, W, and mixtures thereof. Preferred high oxidation activity lanthanide metal oxide is that of La. More preferred higher oxidation activity metal oxides are oxides of V, Cr, Mn, Fe, Co, Ni, Cu, Nb, Mo, or mixtures thereof. Yet more preferred higher oxidation activity metal oxides are oxides of Nb, Mo, Cr, Mn, Fe, Co or Cu. Preferred mixed oxide catalysts of this invention comprise two, three or four high oxidation activity metal oxides.

Selected catalysts of this invention include mixed metal oxides containing 50% by weight or more of titania, silica, alumina or mixtures thereof (a low oxidation activity metal oxide) in combination with one or more metal oxides of V, Cr, Mn, Fe, Co, Ni, Cu, Nb, or Mo. Selected catalysts of this invention include mixed metal oxides containing 50% by weight or more of titania, silica, alumina or mixtures thereof (a low oxidation activity metal oxide mixture) in combination with one or more metal oxides of Cr, Mn, Fe, Co, Cu, Nb, or Mo. Selected catalysts of this invention include mixed metal oxides containing from about 0.1% to about 10% by weight of one or metal oxides of Cr, Mn, Fe, Co, Cu, Nb, or Mo wherein the remainder of the catalyst is titania, zirconia, silica, alumina or a mixture thereof. Selected catalysts of this invention include mixed metal oxides containing about 0.1% to about 15% by weight of an oxide of Mo and optionally about 0.1% to about 10% by weight of one or more metal oxides of Nb, Fe, Co or Cu wherein the remainder of the catalyst is titania, zirconia, silica, alumina or a mixture thereof.

Selected catalysts of this invention include mixed metal oxides containing 75% by weight or more of titania, silica, alumina or mixtures thereof (a low oxidation activity metal oxide) in combination with one or more metal oxides of V, Cr, Mn, Fe, Co, Ni, Cu, Nb, or Mo. Selected catalysts of this invention include mixed metal oxides containing 75% by weight or more of titania, silica, alumina or mixtures thereof (a low oxidation activity metal oxide mixture) in combination with one or more metal oxides of Cr, Mn, Fe, Co, Cu, Nb, or Mo. Selected catalysts of this invention include mixed metal oxides containing from about 1% to about 25% by weight of one or more metal oxides of Cr, Mn, Fe, Co, Cu, Nb, or Mo wherein the remainder of the catalyst is titania, zirconia, silica, alumina or a mixture thereof. Selected catalysts of this invention include mixed metal oxides containing about 1% to about 25% by weight of an oxide of Mo. Selected catalysts of this invention include those containing about 0.1% to about 10% by weight of one or more metal oxides of Nb, Fe, Co or Cu and about 0.1% to about 15% by weight of an oxide of Mo wherein the remainder of the catalyst (75% by weight or more) is titania, zirconia, silica, alumina or a mixture thereof.

Selected catalysts of this invention include mixed metal oxides containing about 0.1% to about 25% of an oxide of Mo wherein the remainder of the catalyst is titania, silica, alumina or a mixture thereof. Selected catalysts of this invention also include mixed metal oxides containing about 0.1% to about 10% of an oxide of Mo wherein the remainder of the catalyst is titania, silica, alumina or a mixture thereof. Selected catalysts of this invention also include mixed metal oxides containing about 1% to about 10% by weight of one or more metal oxides of Fe, Co, Cu, or Nb and about 0.1% to about 10% by weight of an oxide of Mo wherein the remainder of the catalyst is titania, silica, alumina or a mixture thereof. Selected catalysts of this invention further include mixed metal oxides containing about 1% to about 10% by weight of one or more metal oxides of Fe, Co, or Cu, 1% to about 10% by weight of niobium oxide and about 0.1% to about 10% by weight of molybdenum oxide wherein the remainder of the catalyst is titania, silica, alumina or a mixture thereof. Preferably the majority component (more preferably 50%-about 90% by weight) of all selected catalysts is titania.

Selected catalysts of this invention further include mixed metal oxides containing about 0.4% to about 6.0% by weight of an oxide of Mo wherein the remainder of the catalyst is titania, zirconia, silica, alumina or a mixture thereof. Selected catalysts of this invention also include mixed metal oxides containing about 0.4% to about 6.0% by weight of an oxide of Mo, and 0.4% to about 6.0% by weight of an oxide of Nb wherein the remainder of the catalyst is titania, zirconia, silica, alumina or a mixture thereof. Selected catalysts of this invention further include mixed metal oxides containing about 4% to about 6% by weight of an oxide of Fe; Co, Cu, Nb or a mixture thereof, and about 0.4% to about 6.0% by weight of an oxide of Mo wherein the remainder of the catalyst is titania, zirconia, silica, alumina or a mixture thereof. Selected catalysts of this invention also include mixed metal oxides containing about 4% to about 6% by weight of an oxide of Fe; Co or Cu or a mixture thereof, about 4% to about 6% by weight of an oxide of Nb and about 0.5% to about 1% by weight of an oxide of Mo wherein the remainder of the catalyst is titania, silica, alumina or a mixture thereof. Preferably the majority component (more preferably 50%-about 90% by weight) of all selected catalysts is titania. In specific embodiments the mixed metal catalysts of this invention are generated by coforming methods.

Exemplary catalysts of this invention include those which comprise about 0.4% to about 6% by weight of molybdenum oxide in combination with titania, zirconia, silica, alumina or a mixture thereof. Exemplary catalysts of this invention include those which comprise about 0.4% to about 6% by weight of and about 0.4% to about 6% by weight of niobium oxide in combination with titania, zirconia, silica, alumina or a mixture thereof. Exemplary catalysts of this invention also include those which comprise about 4% to 6% by weight of iron oxide; cobalt oxide or copper oxide or a mixture thereof, about 4% to about 6% by weight of niobium oxide and about 0.4% to about 6% by weight of molybdenum oxide in combination with titania, zirconia, silica, alumina or a mixture thereof. Exemplary catalysts of this invention include those which comprise about 4% to 6% by weight of iron oxide, cobalt oxide, or copper oxide or a mixture thereof, about 4% to about 6% by weight of niobium oxide and about 0.5% to about 1% by weight of molybdenum oxide in combination with titania. Further exemplary catalysts of this invention include those which comprise about 5% by weight Iron oxide; cobalt oxide or copper oxide, about 5% by weight of niobium oxide and about 0.5% to about 1% by weight of molybdenum oxide in combination with titania, zirconia, silica, alumina or a mixture thereof. Yet further exemplary catalysts of this invention include those which comprise about 5% by weight Iron oxide; cobalt oxide or copper oxide, about 5% by weight of niobium oxide and about 0.5% to about 1% by weight of molybdenum oxide in combination with titania.

In specific embodiments the catalysts of this invention include those where the catalyst is formed from a low oxidation activity oxide support that is resistant to sulfation, for example, a support of silica (SiO₂), titania (TiO₂) or a mixture thereof, that has been modified to contain 1% to about 10% of a first higher oxidation activity metal oxide chosen from metal oxides of V, Cr, Mn, Fe, Co, Ni, Cu, Nb, Mo, Tc, Ru, Rh, Hf, Ta, W, Au, La, Ce, Pr, Nd, Pm, Eu, Gd, Tb, Dy, Ho, Er, Tm, Yb, and Lu and then further modified with a second and third higher oxidation activity metal oxide wherein the first, second and third higher oxidation activity metal oxides are oxides of different metals. Preferred modifying higher activity metal oxides are those of Mo, Nb, Fe, Cr, Cu and Co.

The catalysts of this invention can be prepared by any method of combination of methods known in the art. However, the catalysts are preferably prepared by co-forming methods or by a combination of co-forming and impregnation techniques as described in the Examples. Coprecipitation and combinations of coprecipitation and impregnation or coprecipitation and co-forming and combinations thereof can also be used to prepare the catalysts. Starting materials (various metal compounds) for preparation of the catalysts herein are readily available. As is known in the art, starting materials may contain low levels of impurities, particularly metal impurities, in general such impurities have not been found to affect catalytic activity. Higher purity starting materials may be employed or art-known methods may be employed to purify starting materials in those cases in which a detrimental affect of impurities on activity is detected.

Technical grade materials (generally containing 95% or more by weight of the chemical of interest) are sufficiently pure for preparing the preferred catalysts. Small levels of impurities of various metals (V, Cr, Mn, Fe, Co, Ni, Cu, Nb, Mo, Tc, Ru, Rh, Pd, Hf, Ta, W, Re, Os, Ir, Pt, Au, La, Ce, Pr, Nd, Pm, Sm, Eu, Gd, Tb, Dy, Ho, Er, Tm, Yb, Lu) present as impurities will not significantly adversely affect catalytic properties.

The catalysts of this invention are prepared as metal oxides. After exposure to gas streams containing H₂S, SO₂ and/or other sulfur-containing species, the catalysts may be converted at least in part to sulfide or sulfate which are active for oxidation. In addition, the oxidation states of the metal oxides may change during the reaction or pretreatment.

Metal oxide catalysts of this invention can be characterized by XRD, XPS, XRF and multi-point BET pore size distribution assays, if desired. Pore size and pore-size distribution of the catalysts herein can be adjusted if desired employing methods that are well-known in the art. For example, the pore size and pore-size distribution of a given catalyst can be increased by the addition of pore-forming precursor materials to the metal oxide powders, such as hydroxymethylcellulose or polyethylene glycol, which will burn away during calcination, leaving behind larger pores.

The surface area of a given catalyst can be measured using methods that are well-known in the art and surface area of a given catalyst can be adjusted or selected using methods that are well-known in the art.

The inventive catalysts and methods herein can be used generally in any application where either SO₂ or sulfur or a selected combination of both are desired products and H₂S is available as feedstock. Sulfur dioxide or sulfur may be desired as a starting material or reagent (e.g., SO₂ may be employed as an oxidizing agent) in a process (e.g., in a synthetic process). Alternatively, the inventive catalyst can be employed to remove undesired H₂S present in a gas stream. In this case, SO₂ and/or sulfur may be more readily removed from a given gas stream than H₂S.

The catalysts and catalytic processes of this invention are designed to oxidize H₂S to elemental sulfur, SO₂ or both in gas stream that contains H₂S concentrations from a few ppm up to tens-of-percents. The inventive process can generally be used to remove or decrease the levels of H₂S in the gas stream, to generate elemental sulfur for various applications, to generate SO₂ for various purposes, to generate a selected mixture of SO₂ and sulfur or a selected mixture of H₂S and SO₂.

The largest single use of SO₂ is as a feedstock for oxidation into SO₃ for H₂SO₄ manufacture. Most of the SO₂ produced for H₂SO₄ is made by burning elemental sulfur, and there are several designs of sulfur burners known and used in the art that contact molten sulfur with air. In the burning process, both SO₂ and SO₃ are made, however, the burners are typically operated to minimize SO₃ formation because, if there are any traces of water in the system, H₂SO₄ mists can form which are corrosive to the burner. The catalytic process of this invention can be used to produce SO₂ substantially in the absence of SO₃ and can be employed to generate SO₂ for various applications from gas streams containing H₂S.

Again in general, the inventive catalysts, the catalytic oxidation method employing them and a catalytic reactor carrying out the oxidation method can be combined upstream or downstream as appropriate with any one or more compatible sulfur recovery or removal processes that are known in the art. The method herein can in general be combined with any art-known sulfur recovery or removal process that can be operated such that the pressure range, temperature range, and/or component concentration (e.g., H₂S, O₂, etc.) range, if any, of any gas stream(s) linking the processes are within (or can be reasonably adjusted to be) the operational range of the inventive process.

For example, the inventive process can be operated downstream of a chemical or catalytic process in which various sulfur-containing species in a gas stream are converted to H₂S. More specifically, the H₂S oxidization methods herein can be combined with known methods (e.g., hydrogenation/hydrolysis process) for converting other sulfur containing species, such as SO₂, COS, CS₂ and/or mercaptans (e.g, RSH, R is aliphatic) to H₂S.

The inventive process can be operated downstream of a combustion, adsorption, fractionation or reactive process which decreases the level of any undesired gas component, e.g., H₂S (assuming residual H₂S remains), SO₂, particulates, aerosols (e.g., containing hydrocarbons), condensate (e.g., containing heavier hydrocarbons), heavier hydrocarbons, etc. The inventive process can be operated downstream of concentration, fractionation, adsorption or reactive process that increases the level of any desired gas component. The inventive process can be operated downstream of a less-than-completely efficient sulfur removal process for removal of residual H₂S to increase efficiency.

Alternatively, or in combination, the inventive process can be operated upstream of a sulfur removal process (chemical or biological) to decrease the sulfur load on that process. The inventive process of this invention can also be operated upstream of a sulfur removal or recovery system that requires or exhibits improved operation at a selected ratio of H₂S to SO₂. The inventive process of this invention can be operated upstream of a sulfur removal or recovery system that is detrimentally affected by the presence of SO₂ to reduce SO₂ levels entering the system and improving overall efficiency.

Compatible processes can be linked, typically by transfer of a product gas stream from one process to the feed inlet of another process directly or by intervening cooling, heating, pressure adjustment, water removal, solvent removal, filtering equipment or related processing equipment as will be appreciated by those of ordinary skill in the art.

Selective oxidation of H₂S in the presence of other oxidizable components is achieved by use of catalysts herein, in appropriate catalytic reactor systems, and with selection of the temperature at which the catalytic reaction is conducted. In general, any type of catalytic reactor can be employed that is appropriate for bringing the gas stream to be treated into contact with the catalyst and other reactant (air or oxygen). Fixed bed and fluidized bed reactors can be employed. Typically the feed gas stream is heated sufficiently high before entering the catalytic reactor such that the temperature in the reactor is within a relatively small range around a selected temperature. A catalytic reactor for conducting the H₂S oxidation of this invention can, alternatively or in addition, be provided with a heater or cooling equipment as needed to maintain the desired temperature range. A catalytic reactor for the inventive process can optionally include metering valves for controlling gas streams entering and leaving the reactor. Gas flows (e.g., component concentrations), pressures and temperatures in the reactor can be measured and controlled using methods and equipment that is well-known in the art.

The temperature of the reaction is kept below about 400° C. to avoid or minimize unwanted oxidation and to decrease energy requirements. Generally, the more active the metal oxide catalyst, the lower the reaction temperature that should be used with the caveat that the reaction temperature should be maintained sufficiently above the sulfur dew point to avoid detrimental levels of sulfur condensation in the reactor. Sulfur condensation onto the catalyst which can lead to catalyst deactivation and may require catalyst regeneration is preferably avoided. The more preferred temperature range for operation is between about 160° C. to about 250° C., dependent upon the sulfur dew point.

Methods of this invention can be used to oxidize H₂S substantially to S (with less than about 10-15 mol % SO₂) or substantially to SO₂ (with less than about 10 mol % S). Methods of this invention can be used to oxidize H₂S essentially to S (with less than about 5 mol % of SO₂) or essentially to SO₂ (with less than about 5 mol % of S.)

The catalysts and catalytic process of this invention are selective for the oxidation of H₂S in the presence of various other oxidizable species, including aliphatic and aromatic hydrocarbons, CO and H₂, as well as in the presence of non-oxidizable components such as CO₂.

Because methane, BTEX and NGL (natural gas liquid) hydrocarbons are not oxidized during H₂S oxidation at temperatures below about 300° C., the inventive process can be used to directly desulfurize natural gas streams that contain either low or high concentrations of methane and CO₂ as well as BTEX and NGL hydrocarbons.

A wide range of natural gas compositions can be treated for sulfur removal by the processes of this invention. Table 2 lists a field composition for a low concentration methane gas and Table 3 lists the composition of a methane-rich gas. Either gas can be effectively treated using the inventive direct oxidation process of this invention or employing sulfur removal and recovery processes of this invention in which the direct oxidation process is combined with art-known sulfur recovery or removal systems.

TABLE 2
Typical composition of a
methane poor natural gas.

| Parameter | Value |
|---|---|
| H₂S | 2000 ppm |
| CO₂ | 84.46 vol % |
| N₂ | Negligible |
| CH₄ | 9.95 vol % |
| C₂H₆ | 2.99 vol % |
| C₃H₈ | 1.99 vol % |
| Other | 0.32 vol % |
| Temperature | 60-100° F. |
| Pressure | 250-340 psig |
| Humidity | Sat. at 100° F. |

TABLE 3
A composition for a methane-rich gas.

| Property | Value |
|---|---|
| Temperature | 85-100° F. |
| Pressure | Up to 1000 psig |
| Hydrogen sulfide (H₂S) | 0.2 mol % (2000 ppm) |
| Nitrogen (N₂) | 0.3 mol % |
| Carbon Dioxide (CO₂) | 0.54 mol % |
| Methane (CH₄) | 95.1 mol % |
| Ethane (C₂H₆) | 1.84 mol % |
| Propane (C₃H₈) | 0.72 mol % |
| Butanes (C₄H₁₀) | 0.61 mol % |
| Pentanes (C₅H₁₂) | 0.315 mol % |
| Hexanes (C₆H₁₄) | 0.23 mol % |
| Benzene (C₆H₆) | 0.07 mol % |
| Toluene (C₆H₅CH₃) | 0.026 mol % |
| Xylenes (C₆H₄(CH₃)₂) | 0.01 mol % |
| Total BTX | 1060 ppmv |

Further, the inventive process of combination processes of this invention can be used to desulfurize (or at least reduce the level of sulfur containing compounds in) synthesis gas streams and gasification product gas streams that contain CO and H₂. An example composition of Syngas from a gasifier is listed in Table 4.

TABLE 4
An Example Composition of
Syngas from a Gasifier

| | |
|---|---|
| Hydrogen (H₂) | 40% |
| Carbon dioxide (CO₂) | 15% |
| Methane (CH₄) | 2% |
| Carbon Monoxide (CO) | 41-42% |
| Hydrogen sulfide (H₂S) | 1-2% |
| Water vapor (H₂O) | Saturated |

The direct oxidation process of this invention can be employed alone or in combination with other sulfur removal or recovery systems for high-pressure as well as low pressure gas streams for H₂S removal. Typically low pressure gas streams constitute gas streams at 0-50 psi and high pressure gas streams constitute streams that are available at pressures higher than 50 psi. All of the processes that follow the direct oxidation process can be operated at high pressures, typically up to 1000 psi. In addition to natural gas streams and synthesis gas, the processes herein are also specifically applicable to removal of H₂S from refinery fuel gas, from gas streams of CO₂ floods, from gases of geothermal sources, and from gases generated during waste water treatment.

Direct Oxidation of H₂S with Optional Sulfur Recycling and Tail Gas Treatment

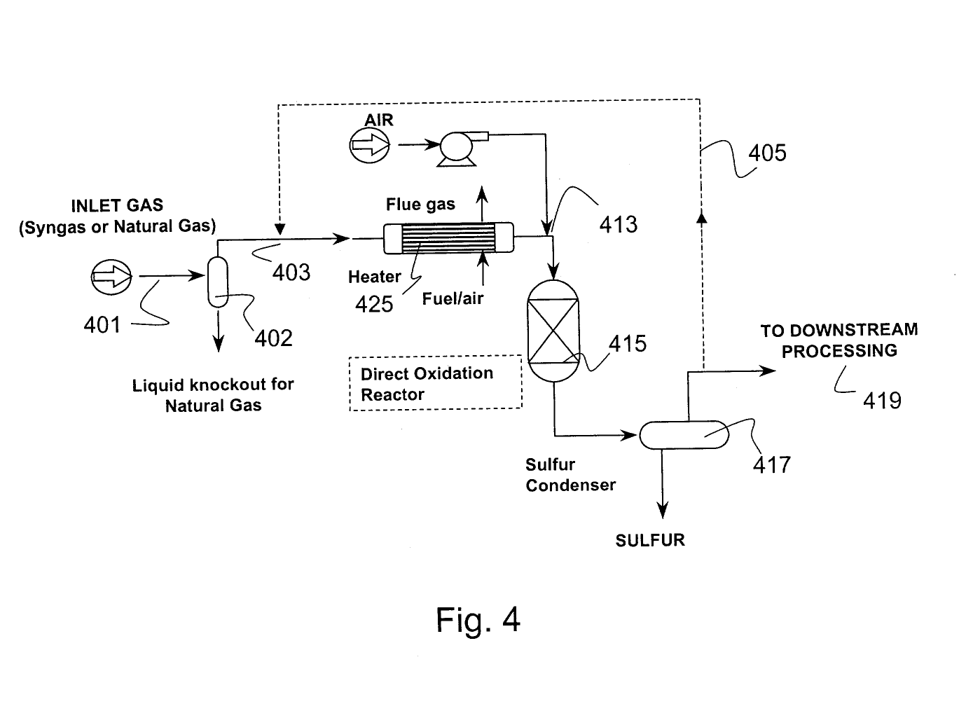

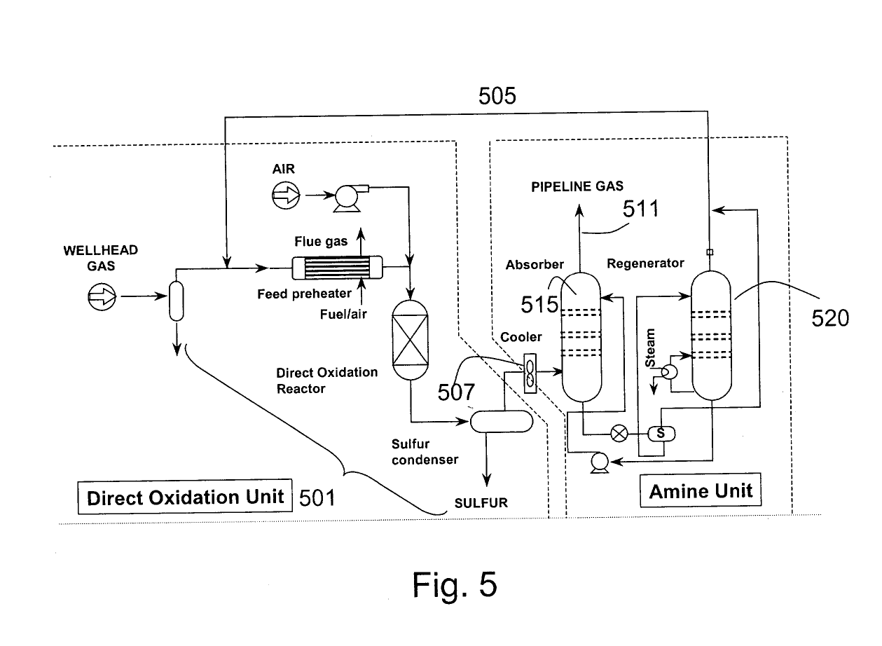

The catalysts and methods of this invention can be used in a direct oxidation process to recover elemental sulfur from a sour natural gas stream. FIG. 4 illustrates an exemplary selective oxidation process and FIG. 5 illustrates a direct oxidation reactor upstream of a standard amine unit which exemplifies downstream processing with a tail gas treatment unit which separates acid gases from the process stream and allows H₂S and/or SO₂ to be cycled back to the direct oxidation unit.

The process is illustrated for application to natural gas or syngas treatment. In the illustrated process, sour gas first enters a knockout drum (402) via inlet 401 where any natural gas liquids are removed. The use of a knockout drum or related device element is optional and dependent upon the components present in the gas stream to be treated. The sour gas (403, the term is used generically herein to refer to gas streams containing H₂S and or H₂S and SO₂) is then heated (heater, 425) to a temperature at least above the dew point of sulfur (calculated for 95% conversion of H₂S into elemental sulfur), mixed with air (inlet 413) and passed into the catalytic reactor (415). In certain configurations, the gas is heated to a temperature such that the gas will be at the desired reaction temperature when it reaches the catalytic reactor. In other configurations, the catalytic reactor may be provided with heaters and or temperature control to allow selection of reaction temperature.

The mixture of air and sour gas enters the catalytic reactor (415) which contains the direct oxidation catalyst. This catalytic reactor can have any design appropriate for the selected reaction conditions and specifically can be either a fixed bed or fluidized bed reactor. The air flow rate is adjusted (flow meter not shown) so that the of oxygen to hydrogen sulfide is preferably between about 0.4 and about 5 and more preferably O₂/H₂S=about 0.5.

The catalytic reactor is operated above the dew point of the sulfur in the system to avoid undesired condensation of sulfur in the reactor and to facilitate recovery of the sulfur by condensation of the sulfur vapor in a condenser. The dew point temperature determines the minimum usable catalyst bed temperature (to avoid condensation in the bed) and this is a function of the inlet H₂S concentration and H₂S conversion in the catalytic reactor. Dew point temperatures for different starting sulfur vapor concentrations are readily calculated using known methods. The preferred operating temperature of the catalyst bed is between about 160° C. and about 250° C., more preferably between about 170° C. and about 200° C., depending on the amount of H₂S in the feed stream. The direct oxidation catalyst (compositions as described above, for example, TDA #1, TDA #2 and/or TDA #3) makes a small amount of SO₂ in addition to elemental sulfur. Sulfur vapor, small amounts of SO₂, CO₂, water vapor and unreacted H₂S exit the direct oxidation reactor and enter the sulfur condenser (417). Sulfur is condensed as a liquid and is sent to storage.. The condenser is operated at a temperature low enough to collect sulfur as a liquid, but not so low that solid sulfur freezes in the condenser. The processed gas stream is passed downstream (outlet 419) for further processing (e.g., tail gas treatment) if required. Gas exiting the sulfur condenser may optionally be recycled (405) back through the catalytic reactor. If the H₂S content of the processed gas stream is sufficiently low, the treated gas may be flared or passed to an incinerator.

The configuration of FIG. 5 is an exemplary configuration used to increase sulfur recovery. H₂S, SO₂ or both are removed by the amine unit and recycled (505) back to the direct oxidation reactor (501) where recycled H₂S and SO₂ are converted to additional sulfur. The gas exiting the sulfur condenser (507) is further cooled (air-fin cooler exemplified) before entering a standard amine gas absorption system (absorber 515 and regenerator 520). The amine chosen for use in the absorber depends on the composition of the gas exiting the sulfur condenser, which in turn, is a function of the composition of the natural gas being treated by direct oxidation. In general, the amine is selected to maximize removal of H₂S, SO₂ and CO₂ in the absorption step. The absorber is preferably designed so that the sweetened gas (exiting at outlet 511) meets pipeline specifications. The use and operation of amine gas absorption systems is well-known in the art. Rich amine from the gas absorber is sent to the amine regeneration unit (520). Stripped gas (enriched in H₂S, SO₂ and CO₂) from the regenerator is recycled (505) to the direct oxidation reactor (501). The recycle stream (505) from the amine unit regenerator is mixed with the incoming sour gas and heated. The direct oxidation reaction is responsible for recovering the sulfur present (believed to recover 85-95% of the sulfur present) in the natural gas. The direct oxidation of H₂S (Equation 2) and the Claus reaction of H₂S with SO₂ (Equation 3) function for generation of additional sulfur. In a preferred process configuration in combination with an amine unit, the catalysts and reaction conditions in the catalytic reactor are adjusted to minimize SO₂ generation.

H₂S Oxidation Combined with a Liquid Phase Claus Process

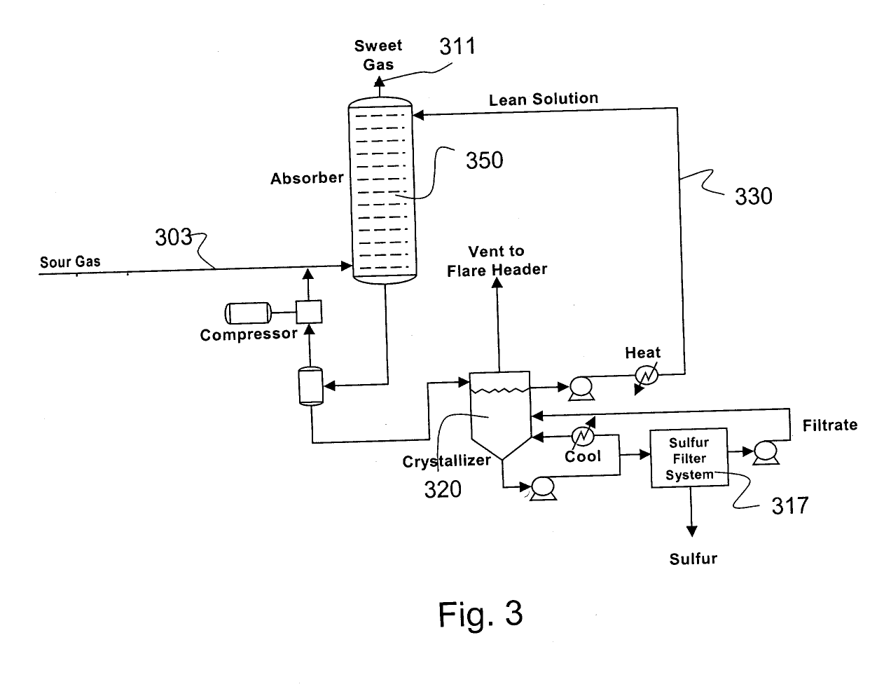

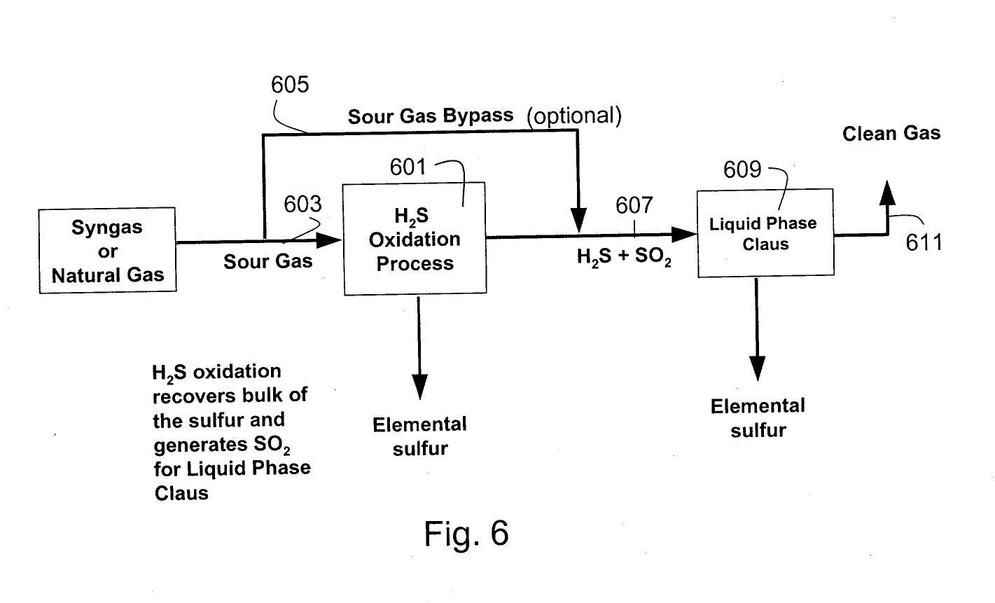

FIG. 6 schematically illustrates a sulfur recovery configuration in which a direct oxidation reactor of this invention (e.g., the reactor of FIG. 4) is positioned upstream of a liquid phase Claus process (aqueous or non-aqueous liquid phase), as exemplified by the non-aqueous liquid phase Crystasulf^{SM} process illustrated in FIG. 3. Again the process is illustrated for treatment of natural gas or synthesis gas, but can also be applied to refinery fuel gas and for hydrogen recycle gas streams in a refinery. Sour gas enters the oxidation process (601) at inlet 603. The inlet line is provided with an optional bypass (605) where a selected portion of the sour gas can be diverted past the oxidation reactor (flow controllers and metering valves not shown). The bypass line rejoins the gas stream exiting (607) the catalytic reactor of the oxidation process. The gas stream exiting the oxidation process along with any sour gas passed through the bypass line is introduced into the liquid phase Claus system (609). For example, the gas stream would be introduced into the absorber (350) of the Crystasulf^{SM} unit illustrated in FIG. 3. Sweetened gas exits the system (611) or may be passed to another process system.

The gas stream can be split using the bypass to adjust the H₂S to SO₂ ratio of the gas that enters the liquid phase Claus unit. Some of the flow passes through the catalytic reactor and preferably all of its H₂S is converted into SO₂. The balance of the stream is then blended with the gas exiting the reactor and this mixture is then sent to the liquid phase Claus (e.g., Crystasulf^{SM}) unit. By controlling the splitting ratio to the catalytic reactor, the blended stream will contain the correct proportions of H₂S and SO₂ for removal of the remaining sulfur using the liquid phase Claus process

The liquid phase Claus process runs the Claus reaction in liquid phase (Equation 3). In a preferred operation, the direct oxidation catalytic process is used to oxidize approximately ⅓ of the H₂S in the natural gas stream into SO₂ (Equation. 1) so that the proper H₂S to SO₂ ratio (2:1) is present in the natural gas when it enters the liquid phase Claus process. The exact amount of gas sent to the catalytic reactor depends on how much elemental sulfur is recovered directly in the H₂S oxidation step. The more sulfur that is recovered from the catalytic step, the greater the proportion of gas flow that must be sent to the reactor. However, the more sulfur that is recovered from the catalytic reactor, the lower the sulfur load for the liquid phase Claus process. Thus, there is a trade off in operation of the combined configuration between the capital and operating costs between the fixed bed reactor and the absorber. The optimum operating conditions depend on the activity of the solid catalyst and its selectivities for SO₂ and elemental sulfur.

Because methane and light hydrocarbons are inert over the catalyst of this invention, the H₂S oxidation can be carried out in-situ in a natural gas stream; no upstream H₂S processing is needed. In-situ oxidation can generate a preferred H₂S/SO₂ ratio of 2:1 within the natural gas stream for feeding to the liquid phase Claus.

In an exemplary embodiment, a selected amount of air (e.g. 3000 ppm for 2000 ppm of H₂S) is mixed with the natural gas and the stream is passed through a fixed bed reactor containing the catalyst. The stream exiting the reactor contains a H₂S/SO₂ ratio of about 2. The gas exiting the reactor contains the original natural gas components plus H₂S and SO₂ in the proper ratio for processing in the liquid phase Claus reaction where H₂S reacts with the SO₂ to produce solid sulfur and water.

The configuration in which direct oxidation is combined with a liquid Claus sulfur removal process, particularly the non-aqueous liquid phase Claus process (e.g., Crystasulf^{SM}) process, can be employed in the treatment of high-pressure as well as low pressure gas streams for H₂S removal.

H₂S Oxidation Combined with Liquid Redox Sulfur Removal

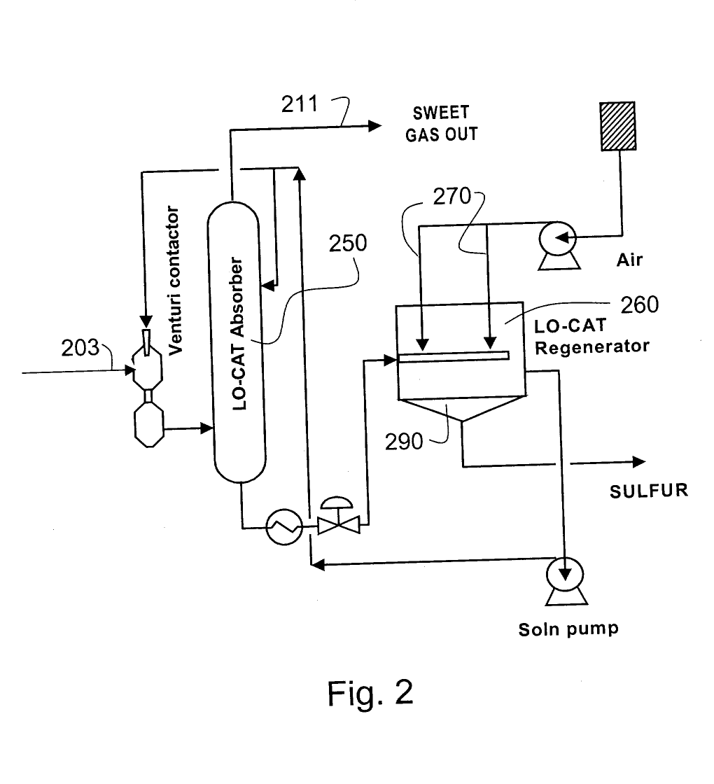

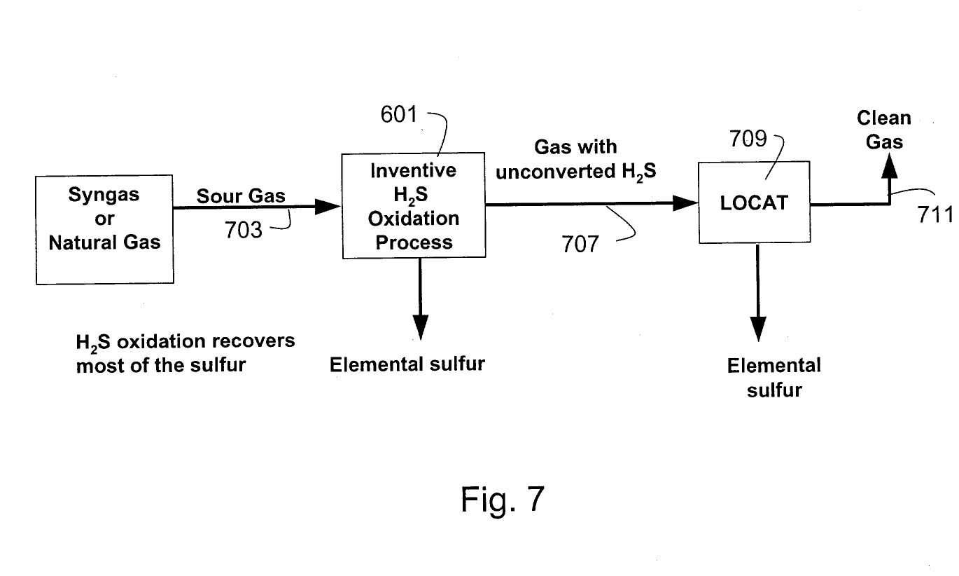

FIG. 7 schematically illustrates a sulfur removal/recovery configuration in which a direct oxidation reactor of this invention (e.g., the reactor of FIG. 4) is positioned upstream of a liquid redox sulfur removal process, as exemplified by the LO-CAT process illustrated in FIG. 2. Again the process is illustrated for treatment of natural gas or synthesis gas, but may be applied to refinery fuel gas and hydrogen recycle streams in refineries. The inventive catalyst and process for sulfur removal can be used upstream of the LO-CAT process to reduce the size of the LO-CAT unit to reduce both capital costs and operating costs for sulfur recovery. Sour gas enters the oxidation process (601) at inlet 703. Elemental sulfur generated by direct oxidation is removed by condensation and gas exiting the oxidation process (707) which contains unconverted H₂S is passed to the liquid redox process (709). For example, the gas stream exiting the oxidation process would be introduced into the LO-CAT absorber illustrated in FIG. 2. Sweetened gas exits the system (711) or may be passed to another processing system.

By using sub-stoichiometric air and operating at a temperature just above the sulfur dew point, the process converts a portion of the H₂S into elemental sulfur, leaving the remainder of the H₂S unconverted. Little or no SO₂ is formed. The product gas exiting the inventive catalytic reactor is then processed in the liquid redox unit. By first removing the bulk of the sulfur with the inventive catalytic process as elemental sulfur, the size of the liquid redox unit, e.g., the LO-CAT unit, can be decreased and the chemical and operating costs of the unit will be lower compared to a unit designed to process all of the original H₂S in the feed stream. The direct oxidation reaction of this invention can in general be combined with any liquid redox process, including the LO-CAT process, the LO-CAT II process and the Sulferox™ process.

H₂S Oxidation Combined with Biological Sulfur Removal

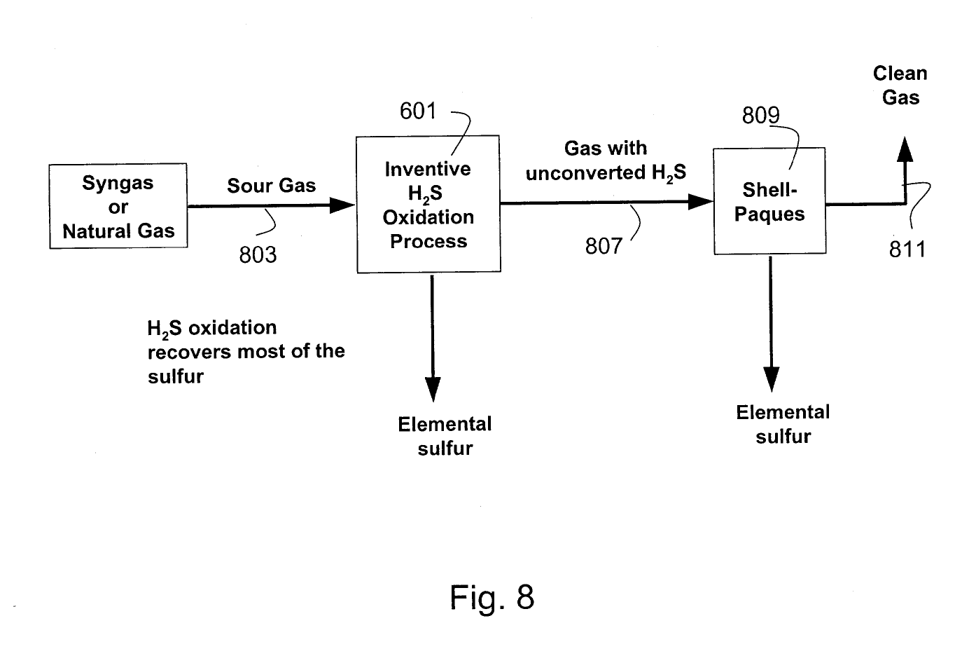

FIG. 8 schematically illustrates an exemplary process configuration combining the direct oxidation reaction of this invention with a biological process for conversion of H₂S and/or SO₂ to sulfur. The process is illustrated for treatment of natural gas or syngas, but can be applied to other gas streams containing sulfur-containing components. In this configuration, sour gas enters (inlet 803) the oxidation reactor (601) and sulfur generated therein is removed by condensation (417). Gas exiting the reactor which may contains unreacted H₂S, is introduced into the biological sulfur removal process (illustrated by the Shell-Paques process). As illustrated the oxidation reaction is operated to maximize partial oxidation to sulfur for removal. In the biological process, H₂S is converted in a first step to sulfide, e.g. in a caustic reactor, and the sulfide is converted by selected microorganisms (e.g., sulfur bacteria) to sulfur. Cleaned or sweetened gas exits the biological process (811) or may be passed to another processing system.

When undesired levels of SO₂ (either SO₂ originally present in the gas stream or SO₂ generated in the oxidation reactor (601) are present), a different biological process can be employed in which any SO₂ present in the gas stream is converted to in a first step to sulfite or sulfate (using for example a sodium bisphosphate solution to absorb SO₂. Absorbed sulfite is reduced by the anaerobic action of a microorganism to sulfide and the sulfide generated is oxidized under aerobic conditions in the presence of a microorganism to sulfur.

H₂S Oxidation Combined with a Split Flow Claus Process

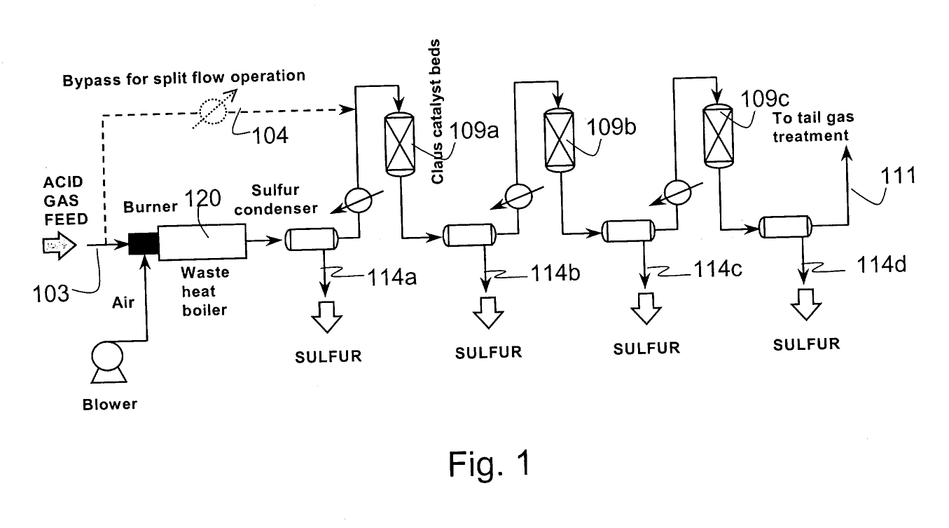

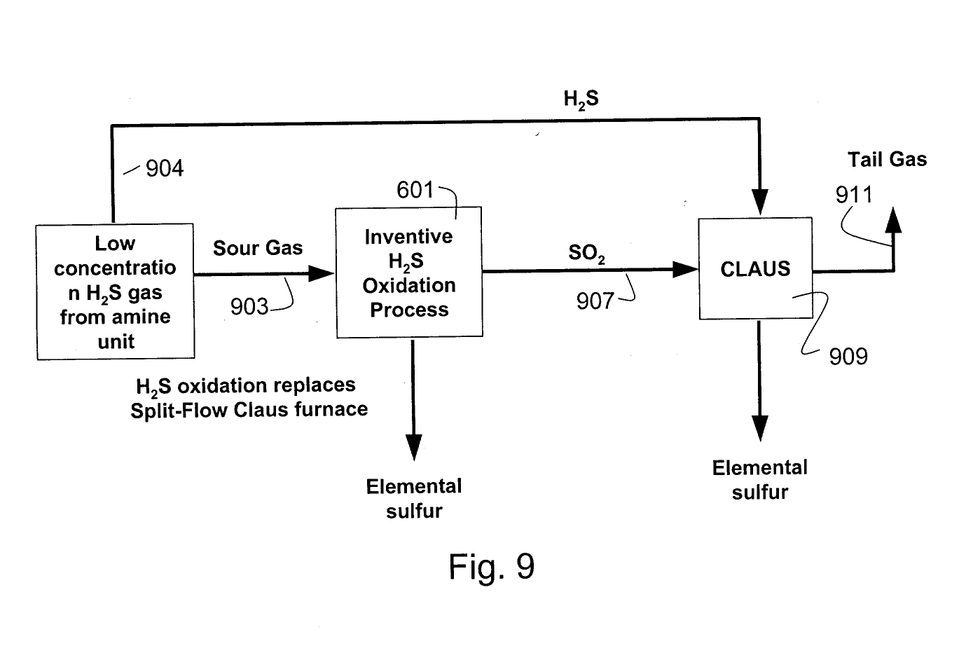

The inventive catalytic oxidation process can be used to replace the furnace in a split flow Claus plant for processing low concentrations of H₂S. The split flow Claus process is typically used for gases containing low concentrations of H₂S and is especially attractive for H₂S concentrations below 12% (1). FIG. 9 schematically illustrates a sulfur removal/recovery configuration in which a direct oxidation reactor of this invention (e.g., the reactor of FIG. 4) is positioned upstream of a liquid Claus unit, as exemplified by the Claus process illustrated in FIG. 1. Sour gas from a source containing a low concentration of H₂S (e.g., 40% or less) is split (904 and 903). A portion of the feed gas stream (904) is directed into the Claus unit (909) and a portion (903) is introduced into the oxidation process (601). By controlling the amount of air added to the catalytic reactor (601) and operating at moderate temperatures (ca<200° C.), H₂S in the split stream (903) can be converted into SO₂ and elemental sulfur. Gas exiting the oxidation process (907) containing SO₂ is passed to the Claus unit and sulfur generated in the oxidation process is condensed. A third or more of the feed gas flow can be sent through the direct oxidation process. Diversion of feed gas flow decreases the total sulfur load on the Claus converters. After processing through the Claus process, elemental sulfur is recovered and tail gas exits the system. Dependent upon the residual levels of H₂S in the tail gas, it may be recycled through the oxidation process or passed into a second catalytic reactor for additional sulfur generation.

Feed gases with H₂S contents below about 12% can be processed without having to add fuel because the H₂S oxidation into SO₂ is catalytic and proceeds at temperatures below 500° C.

H₂S Oxidation Combined with the SCOT (Shell Claus Offgas Treatment) Process

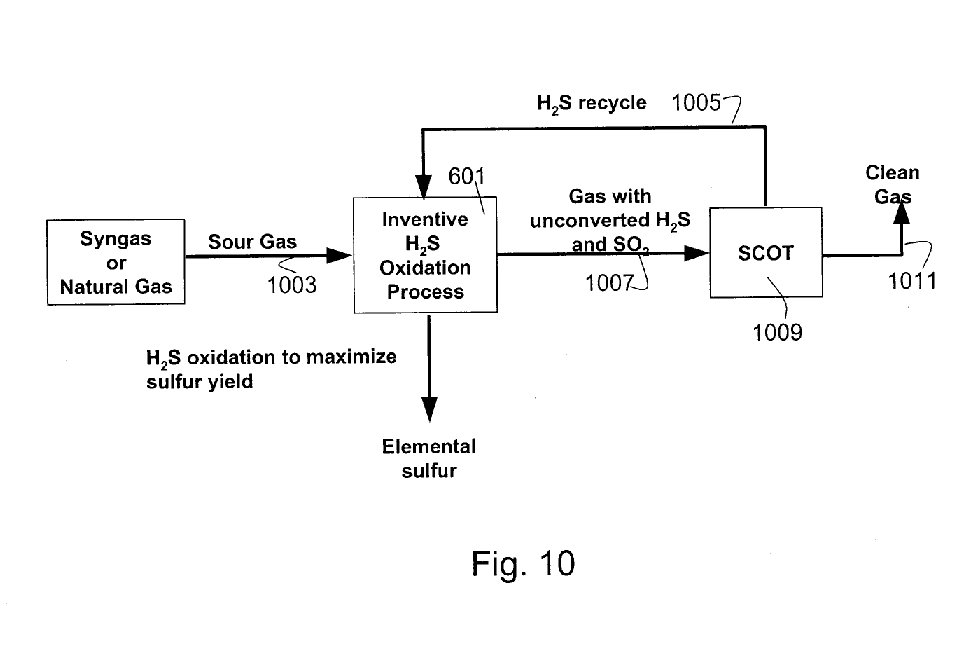

FIG. 10 schematically illustrates a sulfur removal/recovery configuration in which a direct oxidation reactor of this invention (e.g., the reactor of FIG. 4) is positioned upstream of tail gas clean-up unit, such as a SCOT unit. The process is illustrated for treatment of natural gas or synthesis gas. A SCOT process, as is known in the art, has two elements: a hydrogenation/hydrolysis unit, followed by a water quench and an amine gas treatment unit. Tail gas from a Claus unit is introduced into the hydrogenation/hydrolysis unit, heated to 250-300° C. and reacted with a reducing gas (e.g., hydrogen or a mixture of hydrogen and CO) employing a cobalt molybdate catalyst. SO₂, S, COS, CS₂, and other sulfur species in the tail gas are reduced to H₂S. The temperature of the processed gas stream is lowered (water-quench to 180° C. and H₂S is selectively absorbed in an amine unit (using an alkanolamine solution, for example). H₂S is stripped from the absorber solution and recycled back to the hydrogenation/hydrolysis unit.

FIG. 10 illustrates sour gas introduced (1003) into the oxidation process 601. Any unconverted H₂S and SO₂ generated in the oxidation process are passed into the SCOT process (1009) and residual H₂S and H₂S generated during hydrogenation/hydrolysis is recycled back (1005) to the oxidation process. Sweetened gas exits (1011) or is passed to another process system.

In the preferred mode of operation for this scheme, the reactor conditions are adjusted to obtain the highest sulfur yield. Since the SCOT process converts all sulfur compounds to H₂S for recycle, generating some SO₂ in the direct oxidation reactor does not detrimentally affect the process.

Another scheme used to clean up natural gas, syngas, or refinery fuel gas/hydrogen recycle streams is the combination of direct oxidation with the use of a scavenger system behind it. For small sulfur loads, this combination may be more economical than direct oxidation in combination with liquid sulfur recovery systems discussed above. The scavenger system has low capital costs and the disposable scavengers (e.g. iron-based scavengers) provide excellent economics when gas streams contain small quantities of H₂S.

Alternatively the H₂S oxidation process of this invention can be used alone or simply in combination with a hydrogenation/hydrolysis unit to treat Claus tail gas streams.

The processes of this invention are applicable to high-pressure natural gas streams and to the removal of H₂S from a hydrogen recycle stream or refinery hydrotreaters (see Rueter 2002). The processes are also applicable to removal of H₂S from low pressure gas stream, e.g., for treatment of refinery fuel gas, gasification streams, synthesis gas and gas streams from CO₂ floods. The catalysts and catalytic methods of this invention for oxidation of H₂S have been found to selectively oxidize H₂S in the presence of CO and hydrogen without significant oxidation of CO or hydrogen. As a consequence of this finding, the methods and catalysts herein can be used directly to treat syngas to remove H₂S.

More specifically, in the inventive process for desulfurization of gasification products containing CO and hydrogen, a selected amount of oxygen (typically added as air) is added to the gasification product stream and the mixture is contacted with the mixed metal oxide catalyst at temperatures between about 100° C. and about 500° C. preferably between about 160° C. to about 250° C. more preferably between about 170° C. to about 200° C. where H₂S is partially oxidized into elemental sulfur and water or fully oxidized to give SO₂. The relative amounts of H₂S and SO₂ can be selected by adjustment of the O₂ to H₂S ratio in the feed gas for a given catalyst and the temperature. Further, the composition of the catalyst can be chosen and in combination with adjustment of the O₂ to H₂S ratio in the feed gas the relative amounts of H₂S and SO₂ generated by the direct oxidation process can be controlled.

The preferred space velocity of the reaction is between about 100 and about 10,000 m³ of gas/m³ of catalyst/hour, and the processes can be operated at ambient pressure and at higher pressures up to about 1,000 psig.

In the inventive process, the H₂S is oxidized to elemental sulfur and water (and some SO₂) without oxidizing either the CO or H₂ substantially. Because the catalyst will oxidize H₂S but not oxidize CO or H₂, syngas containing H₂S. can be directly treated. A catalyst that oxidizes CO or H₂ would be unsuitable in this application.

For H₂S concentrations below about 5%, the oxidation of H₂S into sulfur and water can be done using an adiabatic fixed bed reactor. For concentrations higher than about 5% by volume, internal cooling or multiple stage reactors can be used to remove the exothermic heat of reaction of H₂S oxidation.

Table 5 summarizes experimental test results (detailed in the Examples) for several exemplary catalysts of this invention. The copper promoted catalyst (TDA #1) exhibited an average H₂S conversion of about 70% and selectivity for SO₂ of about 30% which corresponds to only a 21% yield of SO₂. The yield (product of selectivity and conversion) of elemental sulfur was only 49%. The copper-promoted catalyst would be preferred if larger amounts of sulfur were desired relative to SO₂.

The performance of the TDA #2 catalyst (Fe-promoted) was considerably better than catalyst TDA #1 for the production of SO₂, especially when the O₂/H₂S ratio was 1.5. At this higher O₂/H₂S ratio, the H₂S conversion was complete (100%), the selectivity to sulfur was only 8%, and the selectivity to SO₂ was 92%. When the O₂/H₂S ratio was decreased to 1, the H₂S conversion was slightly reduced (98%), the selectivity to SO₂ was 74% and the sulfur selectivity was 29%. These results correspond to a SO₂ yield of 73% and a sulfur yield of 28%.

The amount of oxygen added (appearing as the O₂/H₂S ratio) is the most sensitive variable found for controlling the selectivity of the catalyst for SO₂ and S. The effect of the O₂/H₂S ratio is greater than the effects of temperature, pressure or space velocity in determining SO₂ yields. The oxygen concentration can thus be adjusted to control the selectivity to SO₂ to different levels as required by the process to which the catalytic oxidation is applied.

The performance of the TDA#3 catalyst (the Co-promoted catalyst) was very similar to that of TDA #2 (the Fe-promoted catalyst) when O₂/H₂S was adjusted to 1. However, increasing the O₂/H₂S ratio to 1.5 clearly improved the performance of both catalysts, with the Co-promoted catalyst being slightly better than the analogous Fe-promoted catalyst. The Co-promoted catalyst exhibits a somewhat higher selectivity for SO₂ than for S.

TABLE 5
Summary of catalyst test results

| | | | | | HC | H₂S | SO₂ | Sulfur |
|---|---|---|---|---|---|---|---|---|
| | | | P | GHSV | added to | conversion | yield | yield |
| Catalyst | O₂./H₂S | T(° C.) | (psig) | (h⁻¹) | feed | (%) | (%) | (%) |
| TDA #1 | 1.0 | 250 | 250 | 1910 | 10% CH₄ | 70 | 27 | 43 |
| TDA #2 | 1.0 | 250 | 300 | 3350 | 10% CH₄ | 96 | 69 | 27 |
| TDA #2 | 1.5 | 250 | 300 | 3350 | 10% CH₄ | 100 | 92 | 8.6 |
| TDA #3 | 1.0 | 250 | 300 | 3350 | 10% CH₄ | 100 | 74 | 26 |
| TDA #3 | 1.5 | 250 | 300 | 3350 | 10% CH₄ | 100 | 94 | 6 |
| TDA #3 | 1.5 | 250 | 300 | 3350 | 10% CH₄ | 100 | 96+ | 4 |
| TDA #3 | 1.5 | 250 | 200 | 3350 | 500 ppm | 100 | 100 | 0 |
| | | | | | n-hexane | | | |
| TDA #2 | 1.5 | 250 | 300 | 2680 | 4400 ppm | 98 | 96 | 3 |
| | | | | | toluene | | | |
| TDA #2 | 1.5 | 225 | 275 | 2680 | 4100 ppm | 94 | 93 | 7 |
| | | | | | o-xylene | | | |
| TDA #2 | 1.5 | 225 | 200 to | 1600 | KO drum | 100 | 70 to | 30 to 2 |
| | | to | 275 | to | vapors | | 98 | |
| | | 250 | | 3350 | | | | |

TDA #2 (5% Fe₂O₃/0.5% MoO₃/5% Nb₂O₅/TiO₂) was subjected to further testing in the presence of toluene, o-xylene and KO drum condensate vapors. When none of these hydrocarbons were present, 100% H₂S conversion was observed with 95+% selectivity to SO₂ at pressures of 200-300 psig, temperatures between 225° C. and 250° C. at space velocities between 1500 and 3300 cm³_{gas}/cm³_{catalyst}/hr (at P and T). In these tests, the H₂S concentration was 2000 ppm and the O₂ concentration was 3000 ppm (O₂/H₂S=1.5, stoichiometric for SO₂).

When the TDA #2 catalyst was operated under identical conditions, but with the addition of toluene (4400 ppm), o-xylene (4100 ppm) and KO vapors (3400 ppm estimated), no catalyst deactivation was observed during the experiments that were run for up to 85 hours. The effect of the presence of these (mostly aromatic) hydrocarbon vapors was a modest reduction in the selectivity to SO₂ (from about 90+% down to about 70-80% selectivity) with no change in H₂S conversion (still 100% at O₂/H₂S=1.5, T=225° C., P=275 psig and GHSV=3300 cm³_{gas}/cm³_{catalyst}/hr). The total BTX concentration that can be found in a natural gas sample (as illustrated in Table 3) is in the range of 1000's of ppm. The test results show that TDA #2 catalyst performs well even under conditions where the aromatic contaminant concentrations are 3-4 times as large might be anticipated.

By adjusting the amount of air (O₂) added to the gas stream, the catalyst temperature and the catalyst composition, the ratio of elemental sulfur to SO₂ exiting the catalytic reactor can be adjusted to a selected value. This was demonstrated by the tests with the Cu-promoted catalyst and O₂/H₂S=1.0 and O₂/H₂S=0.7). This ability to selectively adjust the relative yields of elemental sulfur and SO₂ provides a very flexible oxidation process that can be optimized for use as an upstream technology for various sulfur recovery processes, including liquid-redox-processes, conventional Claus processes and liquid phase Claus processes.

The following examples further illustrate the invention, but are in no way intended to unduly limit the invention.

### EXAMPLES

### Example 1

Catalyst Synthesis

Impregnation

A base catalyst is a 0.5% molybdenum oxide/5% niobium oxide/TiO₂ catalyst used in direct oxidation and is described in U.S. Pat. No. 6,099,819 (Srinivas and Bai, 2000) which is incorporated by reference herein for its description of such catalysts. The base catalyst used in examples herein was made by co-forming molybdenum oxide, niobium oxide, and TiO₂ (anatase) powders in the selected proportions. The base catalyst was impregnated with aqueous solutions of Cu(NO₃)₂, Fe(NO₃)₃ or Co(NO₃)₂. The impregnated catalysts were then dried overnight and calcined. Four to five grams of 60-80 mesh catalyst particles were used in the catalyst tests.

Preparation of Co-Formed Powders

An example of one method of formulating a preferred catalyst for the oxidation of H₂S into SO₂ and S is to take 94.5 grams of titanium dioxide (TiO₂) which is in the anatase phase, and mix it with 5 grams of niobium oxide (Nb₂O₅) and 0.5 grams of molybdenum trioxide (MoO₃). The mixed powders are then ball milled using inert ceramic grinding media until the particle size is approximately −400 mesh. The mixed powders are then removed from the ball mill apparatus and mixed with 10 grams of colloidal silica solution (such as Ludox AS30). Ludox AS30 (Dupont) is a 30 wt % suspension of colloidal silica that has been stabilized with ammonium ions. Other forms of silica, silica gel or other binders can also be used and the exact nature of the binder is unimportant; however, in the preferred formulation, aluminum oxide is avoided to minimize any sulfation reactions that may occur by reaction of the aluminum oxide with SO₂. The amount of binder can vary from 1 wt % to 25 wt % with the preferred amount being 10% of the original weight of the powder mixture (e.g. 10 gm of binder for each 100 gm of mixed powders). The preferred binder is silica.

After mixing the TiO₂, Nb₂O₅, and MoO₃ powders with the colloidal silica to form a wet catalyst slurry, the catalyst can either be extruded into any desired shape (e.g. pellets or extrudates) or the catalyst can be prepared in a granular form. In the case of pellets or extrudates, the slurry is allowed to dry overnight in ambient air. In the case of granular catalyst, the slurry is allowed to dry in an evaporating dish and is then ground to size after subsequent high temperature drying and calcining.

After the catalyst has dried overnight at room temperature, it is then dried overnight in a drying oven at a temperature between 100° C. and 150° C. to evaporate additional water. Finally, the catalyst is calcined in a muffle furnace at a temperature between 300° C. and 500° C. for 2-8 hours. The preferred calcination conditions are to maintain the temperature in the furnace at 425° C. for 8 hours. The catalyst is then allowed to cool prior to impregnation with compounds to provide the third metal e.g., Cu, Fe, Co, Cr or Mn.

The catalyst pellets, extrudates or granules made from the powdered TiO₂, Nb₂O₅, MoO₃ and binder is then promoted with an oxide of Cu, Fe, Co, Cr or Mn. For example: 35 grams of the granular form of the TiO₂/Nb₂O₅/MoO₃ catalyst was ground and passed through standard screens to a size of −60 to +100 mesh. A solution of 6.34 grams of cobalt (II) nitrate hexahydrate, Co(NO₃)₂.6H₂O, was dissolved in water to give a total solution volume of 25 mL. The 35 grams of TiO₂/Nb₂O₅/MoO₃ catalyst was then impregnated with the 25 mL of cobalt solution. The preparations of the iron and copper promoted catalysts were done in an identical manner except that for iron, 9.3 grams of ferric nitrate nonahydrate Fe(NO₃)₃.9H₂O was used, and for copper, 5.35 gm of cupric nitrate Cu(NO₃)₂.2.5H₂O was used. As before the solution volume as 25 mL in water and was impregnated into 35 gm of TiO₂/Nb₂O₅/MoO₃ catalyst. The impregnated catalyst was then dried overnight at 150° C. and then calcined at 425° C. for 8 hours. The resulting catalyst contains approximately 5 wt % of metal oxide. Any other salt or compound of the third metal, particularly those metals listed above can be used and solvents other than water can be used. The forgoing method with routine modifications can be employed to prepare various mixed metal oxide catalysts of this invention

### Example 2

Catalyst Test Methods

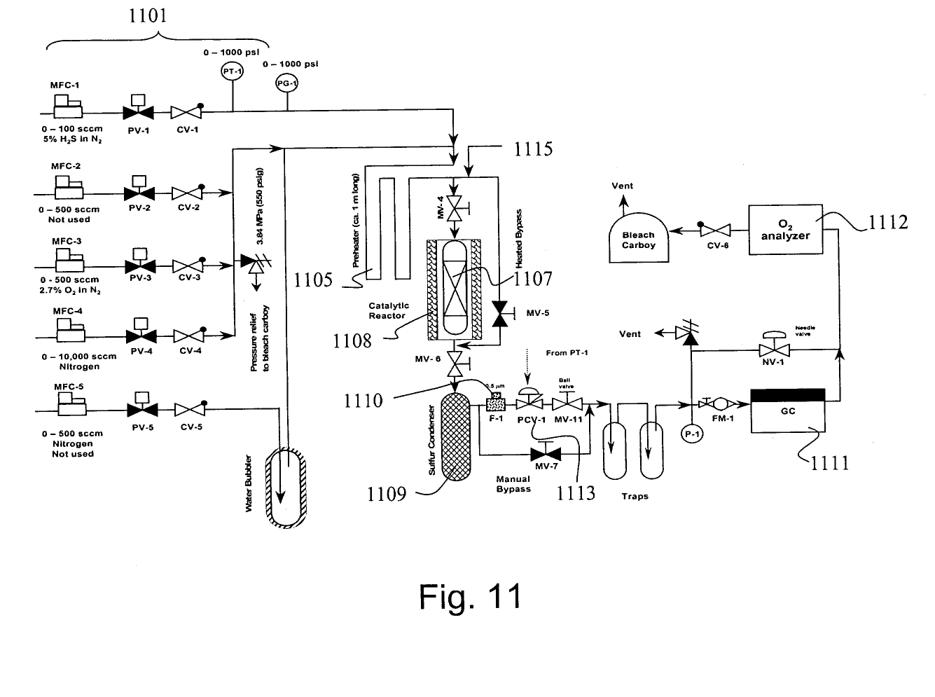

Catalyst testing is performed in a test apparatus as illustrated in FIG. 11. The test apparatus has a gas feed system with mass flow controllers (1101), a water saturator (1103), a heater (1105), a fixed bed reactor (1107), a sulfur condenser (1109), and analytical instrumentation (GC, 1111 and O₂ analyzer 1112)).

Nitrogen, dilute O₂ (2.77% (V/V) O₂ in N₂), dilute H₂S (5% (VNV)H₂S in N_{2), and CH}₄ (or other hydrocarbon in nitrogen) are metered into the apparatus using computer controlled electronic mass flow controllers. Water is introduced by passing one of the N₂ streams through a bubbler (1103) maintained at a temperature that gives the proper partial pressure of water to achieve the desired humidity level. The humid N₂ and the dry O₂ and H₂S streams are mixed in a heat-traced line, and preheated to selected reaction temperature. The preheated feed stream then passes downward over the catalyst that is held in a fixed bed reactor. The reactor (1107) is made from a ½ inch diameter bulkhead Swagelok™ VCR fitting and is equipped with a 2 μm sintered filter gasket at each end to keep the catalyst in place. The reactor is enclosed in a three-zone tube furnace (1108). The process control computer regulates the furnace temperature as well as monitoring and controlling gas flow rates.

H₂S is oxidized by the O₂ into SO₂ and elemental sulfur. The sulfur is collected in a sulfur condenser (1109). The unreacted H₂S and N₂ then pass through filter F1, (1110) and through the pressure control valve (PCV-1, 1113). The pressure control valve is pneumatically actuated and controlled by the process control computer. The pressure upstream of the PCV is maintained at a desired level (e.g. 250 psig) using proportional integral derivative control logic in the process control program (Control EG). Downstream of the PCV, water is condensed in two traps. The gas is then analyzed by gas chromatography (1111) and thereafter passed through a paramagnetic O₂ analyzer (1112). After analysis, the gas is passed into a large carboy filled with bleach (5% NaOCl) that destroys any residual H₂S and SO₂. The scrubbed gas is sent to the laboratory fume hood system. Test components (such as toluene or xylene) can be added to the system (1115).

A: Results for Catalyst TDA #1 (5% CuO/0.5% MoO₃/5% Nb₂O₅/TiO₂).

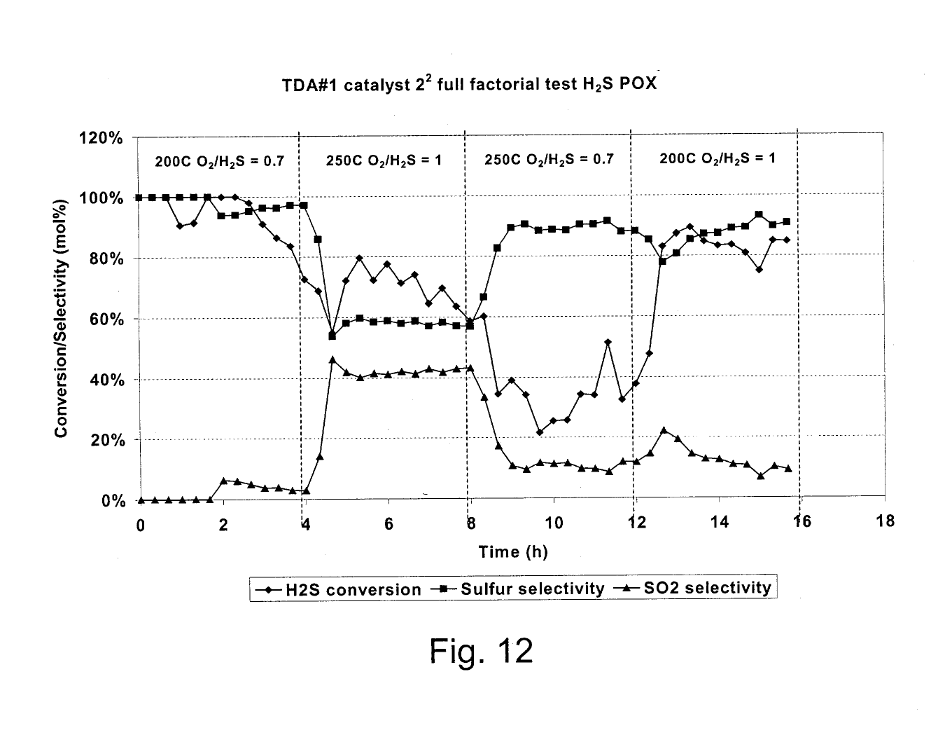

FIG. 12 is a plot of the H₂S conversion, selectivity to SO₂ and selectivity to elemental sulfur for a full factorial experimental design that examined the effects of catalyst temperature and O₂/H₂S ratio. The catalyst was 5% CuO/0.5% MoO₃/5% Nb₂O₅/TiO₂. The experimental variables and responses (conversion and selectivities) are shown in Table 6. The feed gas composition was essentially that shown in Table 2 except that the balance gas was N₂ rather than CO₂ to simplify gas feeding at elevated pressure. The values of conversion and selectivity given in Table 6 are median values from the flat portions of the curves in FIG. 12. The best selectivity to SO₂ was obtained for the higher O₂/H₂S ratio (1.0) and the higher temperature (250° C.). The results shown in Table 6 indicate that the O₂/H₂S ratio has a larger effect (by itself) than temperature for increasing the selectivity to SO₂.

TABLE 6
2² full factorial experimental design with TDA#1 5% Cu/0.5%
MoO₃/5% Nb₂O₅/TiO₂) catalyst.

| Temperature | O₂/H₂S Molar | H₂S | Selectivity to | Selectivity to |
|---|---|---|---|---|
| (° C.) | Ratio | Conversion | SO₂ | Elemental S |
| 200 | 0.7 | 91% | 5% | 97% |
| 250 | 0.7 | 34% | 12% | 89% |
| 200 | 1 | 83% | 13% | 87% |
| 250 | 1 | 78% | 42% | 59% |

Based on the quick screening of process conditions for the TDA #1 catalyst shown in Table 6 a longer test (22 hrs) was run at 250° C. with O₂/H₂S ratio=1 (GHSV=1919 h⁻¹, 250 psi). The average H₂S conversion was approximately 65% slowly increasing to about 70%. The selectivity to elemental sulfur started out at about 70% and decreased slightly to about 60% after 22 hours. Meanwhile, the selectivity to SO₂ increased slightly from 30% to almost 40% over this time period.

No unreacted O₂ slip, as measured with the paramagnetic O₂ analyzer, was observed in the product gas during the 22 hr test with TDA #1 catalyst. This is important because O₂ in the feed gas can degrade the performance of a downstream sulfur removal process, such as the Crystasulf^{SM} process.

A calculated mass balance on O₂ indicated that all of the oxygen present could be accounted for by SO₂; indicating that no SO₃ was being produced. The absence of SO₃ in the product gas is consistent with the equilibrium calculations of the thermodynamic behavior of the system (using HSC Chemistry for Windows). Between 150° C. and 300° C. and starting with 1 mole of H₂S and 1 mole of O₂, SO₃ formation is not thermodynamically favored. While catalysts affect chemical kinetics, the fact that SO₃ formation is energetically unfavorable, suggests that SO₃ formation would not be observed even if the catalytic kinetics for SO₃ formation were favorable.

B. Results for Catalyst TDA #2 (5% Fe₂O₃/0.5% MoO₃/5% Nb₂O₅/TiO₂)

An iron-promoted catalyst (TDA #2) was prepared as indicated in Example 1 and tested as indicated in Example 2A

A 20-hour stability test done with the iron promoted TDA #2. The space velocity was GHSV=3350 cm³_{gas}/cm³_{catalyst}/hr to determine if acceptable activity and selectivity could be obtained at higher flow rates than those used in the testing of TDA #1.

Increasing the flow rate is equivalent to decreasing the amount of catalyst (smaller reactor) or increasing the throughput for a fixed reactor size.

The first experimental conditions were P=300 psig, T=250° C., GHSV=3350 cm³_{gas}/cm³_{catalyst}/hr, H₂S inlet concentration 2000 ppm, and O₂/H₂S=1.5. Based on our observation with the Cu-promoted catalyst that increasing the O₂/H₂S ratio improved both H₂S conversion and selectivity to SO₂, the O₂/H₂S ratio was increased to 1.5 for the TDA #2 Fe-promoted catalyst. At this O₂ concentration (3000 ppm), the H₂S conversion was essentially 100% and the selectivity to SO₂ was 92%. The selectivity to elemental sulfur was 8% by difference. Again no O₂ Slip was observed, and the oxygen mass balance indicated that no SO₃ was produced. When the O₂ concentration was reduced to 2000 ppm (O₂/H₂S=1), the selectivity to SO₂ decreased to about 70% with a corresponding selectivity to elemental sulfur of 30%. Meanwhile, the H₂S conversion dropped slightly to about 97%. Thus, it was concluded that the best performance obtained for the TDA #2 catalyst was at T=250° C. and O₂/H₂S=1.5.

C. Results for Catalyst TDA #3 (5% Co₃O₄/0.5% MoO₃/5% Nb₂O₅/TiO₂)

Table 7 shows the experimental conditions for testing the cobalt promoted catalyst (TDA #3: 5% Co₃O₄/0.5% MoO₃/5% Nb₂O₅/TiO₂). All of the experiments were done with the catalyst at 250° C. and 300 psig. The space velocity was 3350 cm³_{gas}/cm³_{catalyst}/hr. Water vapor was added to give a concentration equivalent to a 100° F. dew point (0.95 psi). This corresponds to a mole fraction of 0.3% at 312 psia. The inlet H₂S concentration was 2000 ppm, and the feed gas contained 10% methane. The experiments were done at two concentrations of oxygen, 2000 ppm (O₂H₂S=1) and 3000 ppm (O₂H₂S=1.5). The balance gas was N₂. H₂=1.5

TABLE 7
Experimental conditions for
test of TDA #3 catalyst.

| Parameter | Value |
|---|---|
| H₂S | 2000 ppm |
| O₂ | 2000 & 3000 ppm |
| N₂ | Balance |
| CH₄ | 10 vol % |
| Temperature | 250° C. |

An experiment was run for approximately 20 hours at T=250° C. and P=300 psig with the O₂/H₂S ratio=1.5. The H₂S conversion observed was 100% during the entire experiment. At the beginning of the experiment the selectivity for sulfur was almost 90% with very little SO₂ being formed. Gradually, over the next 10 hours the selectivities shifted to approximately 10% for sulfur and 90% for SO₂. By 20 hours, the SO₂ selectivity slowly increased to 94% (6% elemental sulfur). Because the H₂S conversion was 100%, the yields of sulfur and SO₂ are numerically equal to their respective selectivities.

H₂S to O₂ Ratio=1.0

The same charge of TDA #3 catalyst was then tested again at O₂/H₂S=1. The time required to reach a steady state selectivity for SO₂ (or S) was much shorter in this test, because the catalyst tested was already sulfated by contact with gases containing H₂S. Some of the longer induction in the previous experiment where O₂/H₂S=1.5, is believed due to conversion of the oxide components in the catalyst to steady state concentrations of sulfide (with possibly chemisorbed sulfite/sulfate because of the presence of oxygen in the feed).

Selectivity for SO₂ was 74% (26% S) when O₂/H₂S=1.0. Again because the H₂S conversion was 100%, the selectivities are numerically equal to the yields for SO₂ and elemental sulfur. Reduced selectivity for SO₂ with decreasing O₂/H₂S is consistent with the results obtained earlier with Cu- and Fe-promoted catalysts.

Paramagnetic O₂ analysis shows that there was no O₂ in the outlet gas so all of the oxygen added to the reactor was being consumed by catalytic reaction.

Oxygen Mass Balance

The test system employed did not allow direct measurement of elemental sulfur produced during the reaction. A calculation of oxygen mass balance was used to check that no SO₃ was formed. The results from the O₂ analyzer indicated that in all of the runs with TDA #3, all of the O₂ was consumed (outlet concentration of zero).

The concentration of sulfur dioxide during testing is measured by gas chromatography (GC) and from this value and the known inlet concentration of H₂S and the known H₂S conversion, the conversions to SO₂ (X_{SO2}) and sulfur (X_{S}) are calculated. The unknown sulfur vapor concentration [S] can then be calculated using the mass balance equations shown in Scheme 1. The amount of O₂ required is calculated and if this is close to the actual inlet concentration of oxygen, then the assumptions in the mass balance are valid and one can conclude that only SO₂ and S are formed.

The inlet concentration of H₂S was [H₂S]₀=2000 ppm, the inlet concentration of oxygen was [O₂]₀=3000 ppm. [O₂]_{req'd} in Scheme 1 is the inlet O₂ concentration that would be required to produce all of the SO₂ and S produced during the experiment. The closer this value is to the inlet O₂ concentration used (i.e. [O₂]₀=3000 ppm) the better the mass balance for oxygen. The inlet concentrations of SO₂ and S were zero.

Scheme 1 provides the equations used for calculating the oxygen mass balance:

$$\begin{matrix} {H}_{2} S + \frac{1}{2} {O}_{2} \to {H}_{2} O + S & \\ {H}_{2} S + \frac{3}{2} {O}_{2} \to {H}_{2} O + {SO}_{2} & {[ {H}_{2} S ]}_{0} = 2000 ppm \\ & {[ {O}_{2} ]}_{0} = 3000 ppm \\ \frac{{[ {H}_{2} S ]}_{0} - [ {H}_{2} S ]}{{[ {H}_{2} S ]}_{0}} = {X}_{{H}_{2} S} & {[ {O}_{2} ]}_{outlet} = 0 \\ \frac{{[ {H}_{2} S ]}_{0} - [ {SO}_{2} ]}{{[ {H}_{2} S ]}_{0}} = {X}_{S} & [ {SO}_{2} ] = {[ {H}_{2} S ]}_{0} - {{X}_{s} [ {H}_{2} S ]}_{0} \\ \frac{{[ {H}_{2} S ]}_{0} - [ S ]}{{[ {H}_{2} S ]}_{0}} = {X}_{{SO}_{2}} = 1 - {X}_{S} & [ S ] = {[ {H}_{2} S ]}_{0} - {{X}_{{SO}_{2}} [ {H}_{2} S ]}_{0} \\ {[ {O}_{2} ]}_{req ' d} = \frac{3}{2} [ {SO}_{2} ] + \frac{1}{2} [ S ] & \end{matrix} \qquad SCHEME 1$$

For the test of TDA #3, the selectivity to SO₂ was X_{SO2}=0.95 (average) and the selectivity to elemental sulfur was X_{S}=0.05 (average). For an inlet concentration of [H₂S]₀=2000 ppm, X_{SO2}=0.95 and X_{S}=0.05, and an SO₂ concentration of 1918.5 ppm, the calculated sulfur vapor concentration is [S]=81.52 ppm. These concentrations of SO₂ and S require [O₂]_{req'd}=1.5(1918.5)+0.5(81.52)=2919 ppm of O₂. The inlet concentration was [O₂]₀=3000 ppm so 97.3% of the oxygen is accounted for by forming only SO₂ and S. This degree of accuracy is well within the experimental accuracy of the mass flow controllers and GC analysis of the product gases. Thus, with TDA #3 catalyst run at O₂/H₂S=1.5, only SO₂ and S are formed and no SO₃ is formed. These results are also consistent with our earlier results for the TDA #1 and TDA #2 catalysts where the oxygen mass balance closure was greater than 95% indicating that only SO₂ and S were formed over these catalysts.

A lack of SO₃ formation is consistent with the literature, which describes the industrial synthesis of SO₃ via SO₂ oxidation (Stocchi 1990). Sulfur trioxide is used for sulfuric acid manufacture and is made by oxidizing SO₂ with O₂ over V₂O₅ catalysts. The optimum temperature for industrial synthesis, from both a kinetic and thermodynamic standpoint, is between 400° C. and 500° C. (Stocchi 1990). These temperatures are much higher than the temperatures used in the process exemplified with TDA #3 catalyst (250° C.) and very poor activity for SO₃ formation would be expected.

Sulfur Dew Point

To avoid bed fouling or equipment plugging, it is preferred o operate a catalytic reactor of this invention in a pressure and temperature regime where any elemental sulfur formed in the reaction will remain in the vapor phase. The experiments reported show that for the best catalysts, the preferred operating temperature was 250° C. The dew point pressure for elemental sulfur at 250° C. determines the maximum concentration of sulfur vapor that can be present over the catalyst. This is linked to the maximum allowable H₂S concentration via the selectivities to SO₂ and sulfur. Higher selectivities to SO₂ permit the processing gases with higher H₂S concentrations.

An example of how the maximum allowable H₂S concentration is calculated is discussed below. Sulfur vapor-liquid-equilibrium (VLE) calculations can be readily performed for different temperatures and concentrations of sulfur vapor. At T=250° C. for 2000 ppm of elemental sulfur vapor condensation starts at a pressure of 72 bar (1044 psi). For the TDA #2 catalyst the best conditions observed were O₂/H₂S=1.5 and T=250° C. Under these conditions the selectivity for sulfur was 30% and the selectivity for SO₂ was 70%. Assuming that the pressure affects the sulfur dew point more than the kinetics of the catalytic reaction, then the maximum concentration of H₂S that could be present in the reactor feed would be 6666 ppm for these values of S and SO₂ catalyst selectivity. These pressures (72 bar) and concentrations (6000+ppm) are somewhat approximate because the calculations do not include corrections for non-ideal gas behavior; however, the calculations do indicate that natural gas streams containing a fairly wide range of H₂S concentrations at pressures of interest (i.e., pressure up to 1000 psi) can be processed in using catalysts of this invention.

### Example 3

Tests with Oxidizable Components Present in the Gas Stream

A: n-Hexane (Simulated Natural Gas Liquids)

In previous catalyst tests, 10% methane was added to the feed. No methane oxidation was observed over TDA #1-3 catalysts at T=250° C. and P=300 psig. Methane is the most difficult of the hydrocarbons to oxidize (highest activation energy) and in the real gas applications, C₂ and higher hydrocarbons are encountered (See Tables 2 and 3.) While the concentrations of these hydrocarbons are a few percent or less each, their oxidation is undesirable because it would consume oxygen, reduce the BTU value of the gas, and most importantly could cause catalyst deactivation (through coke deposition or the deposition of other side-products).

A test of catalyst TDA #3 with feed gas containing 500 ppm of n-hexane (C₆H₁₄) was run at 250° C. and 200 psig in the reactor test system of FIG. 10. Fresh catalyst (never exposed to H₂S) was used and therefore, the compounds in the catalyst were present as oxides. Oxygen was added the system as a flow of 2.7% O₂ in N₂, this flow was started at about 1.5 hours into the run, and during this time the oxygen concentration exiting the reactor rose to and stabilized at 3000 ppm. The appropriate amount of pure N₂ was added to dilute the 2.7% O₂ down to 3000 ppm. At about 2.5 hours, the flow of n-hexane was started. The hexane was introduced from a gas mixture of 990 ppm of C₆H₁₄ in N₂. The gas mixture was added at a flow rate that gave 500 ppm of C₆H₁₄ in the feed gas flowing over the catalyst (pure N₂ was added as to adjust the C₆H₁₄ concentration to 500 ppm). Immediately the O₂ concentration was reduced from 3000 ppm to about 1000 ppm suggesting that hexane oxidation was occurring. The O₂ concentration gradually increased over the next 5 hours and then leveled off at 2000 ppm which corresponds to a consumption of 1000 ppm of O₂. The balanced equation for complete oxidation of C₆H₁₄ into CO₂ and H₂ is:

$${C}_{6} {H}_{14} + \frac{19}{2} {O}_{2} -> 6 {CO}_{2} + 7 {H}_{2} O$$

From the reaction stoichiometry, 1000 ppm of O₂ will oxidize 105.26 ppm of n-hexane. Since the total n-hexane concentration was 500 ppm, the fraction of C₆H₁₄ oxidized over fresh catalyst (no exposure to H₂S) was 21.05%. Because the catalyst had not been exposed to H₂S and was therefore in the oxide form, the catalyst was believed to be in a condition to have its highest possible activity for hydrocarbon oxidation. The fact that even as the oxide, only 21% of the 500 ppm of C₆H₁₄ was oxidized indicates that the catalyst has a fairly low activity for hexane oxidation.

The results of the test with n-hexane in the gas stream was compared with the results of a similar experiment in which H₂S was present in the feed gas. The test apparatus was not configured to analyze for CO, CO₂ and C₆H₁₄ at the low concentrations used. However, if all of the O₂ is consumed, and the sulfur mass balance (unconverted H₂S+SO₂+S) accounts for all (within experimental error) of the O₂ introduced into the reactor, C₆H₁₄ oxidation is negligible.

The test with H₂S present was done with a feed containing 500 ppm of C₆H₁₄, 2000 ppm of H₂S and 3000 ppm of O₂ was about 41 hours long. As in the experiment without H₂S, the flow of 2.7% O₂ in N₂ was established to give an O₂ concentration of 3000 ppm and let the system stabilize. The flow of H₂S was then started and again the concentrations were allowed to stabilize. The pressure was 200 psig, the catalyst temperature was 250° C., the gas was humidified to a concentration that corresponded to the dew point of water at 100° F., and the space velocity was 3350 cm³_{gas}/cm³_{catalyst}/hr. We ran the experiment for about 18 hours under these conditions to achieve steady state H₂S oxidation before adding hexane to the feed. During the “H₂S only” part of the experiment (to 18 hours ), the H₂S conversion was 100% and during this time, the selectivity of the catalyst (the Co-promoted TDA #3 catalyst was used in this test) slowly shifted away from forming about 10% elemental sulfur and 90% SO₂ to virtually 100% selectivity for SO₂.

At 18 h, the 500 ppm hexane flow was started (by this time the SO₂ selectivity and H₂S conversion were both essentially 100% and appeared to have stabilized). The mixed flow of gases (containing C₆H₁₄) was then continued out to over 40 hours when the experiment was stopped. No effect of adding 500 ppm of n-hexane to the feed on either the H₂S conversion or the selectivity to SO₂ was observed.

The results indicate that much less hexane is oxidized when a mixture of H₂S and hexane is added to the catalytic reactor of this invention compared to the level of hexane oxidation observed when no H₂S is present. The mechanism for this difference is not clear, but regardless of the microscopic details, hexane is much less reactive than H₂S over the catalyst under the reaction conditions employed, which indicates that competitive oxidation of higher hydrocarbons will not significantly interfere with the performance of the catalyst when oxidizing H₂S in-situ in natural gas streams.

B: Results of Tests with Toluene and o-Xylene to Simulate BTEX

Many natural gas streams contain small amounts of benzene, toluene, ethylbenzene and xylenes (BTEX). Aromatic hydrocarbons have the potential to foul the catalyst with coke if they decompose on the catalyst without being oxidized.

Acid sites can catalyze carbonium ion cracking and polymerization chemistry that can lead to coke formation (Butt and Petersen 1988; Olah and Molnar 1995). Coke consists of polyaromatic condensed ring structures that tend to be somewhat graphitic in structure (Butt and Petersen 1988). Coking also appears to be more of a polymerization process than a degradation process and thus relatively low molecular weight compounds (e.g. BTEX and C₄ olefins such as butadiene) can lead to significant catalyst fouling if coking occurs on the surface. Nb₂O₅ supported on TiO₂, both components of catalysts of this invention, exhibits acidic behavior which could increase the tendency for coking from BTEX.

Catalyst Tests with Added Toluene

Table 8 lists the flow rates and concentrations of the feed gas that were used in the catalysts test that used toluene as a simulant for BTEX contamination in natural gas. As in previous tests the O₂/H₂S ratio used was 1.5 because this ratio was found to give higher SO₂ selectivity. The pressure (275 psig) and temperature (225° C.) used were previously found to give excellent catalyst performance with TDA Catalyst #3.

Catalyst temperature, system pressure and the concentration of O₂ in the gas were monitored as a function of time. Initially the H₂S+O₂+N₂+H₂O vapor feed was sent through a line that bypasses the reactor to measure the initial concentrations: initial O₂ concentration was 0.3% (3000 ppm) as desired and that the catalyst temperature and system pressure were stable. Four hours into the run, the flow was switched to pass over the catalyst in the reactor. Within a few minutes, the O₂ concentration dropped to zero indicating complete consumption of the 3000 ppm of O₂ in the feed. At the same time the H₂S concentration also dropped to zero and the SO₂ concentration increased to about 2000 ppm indicating that all of the H₂S was being oxidized to SO₂ with essentially no formation of elemental sulfur.

At 5.7 hours, the toluene flow was started at 0.05 mL/min. This amount of liquid gave a final toluene concentration of 4400 ppm. Soon after the introduction of the toluene, the SO₂ concentration decreased to about 1850 ppm and the H₂S concentration increased from zero to 24 ppm. This indicated that the overall catalytic activity dropped about 1.2% and the selectivity for SO₂ decreased from essentially 100% to 94%. This difference suggests that either some elemental sulfur is formed when toluene is introduced into the feed, or that a small amount of the toluene itself is being oxidized.

Because toluene (4400 ppm) is present in over twice the concentration of the H₂S (2000 ppm), it is believed likely that the adsorption of toluene on the catalyst competes with sites for H₂S oxidation. This could either deplete the amount of surface oxygen available for H₂S oxidation (because of consumption by toluene oxidation) or it may be that the site requirement for the H₂S→SO₂ reaction is different than the H₂S→S reaction and that toluene blocks sites needed for total oxidation, just changing catalyst selectivity. Regardless of the mechanism, it appears that there is a minimal effect of toluene on the on catalyst performance. These results indicate that BTX contamination in the natural gas will have little effect on the oxidation of H₂S into SO₂.

A decrease in the reactor temperature to about 140° C. during flow of a feed gas containing the components listed in Table 8 (due to a power disruption) did not lead to poisoning or fouling effect of the toluene.

A calculation of oxygen balance was as discussed above, indicated that no SO₃ was made during H₂S oxidation in the presence of water and toluene.

TABLE 8
Experimental parameters for testing catalyst with
toluene in the feed.

| Parameter | Value |
|---|---|
| H₂S concentration | 2000 ppmv |
| O₂ concentration | 3000 ppmv |
| H₂O concentration | 0.95 psi |
| N₂ concentration | 98.7% |
| Toluene concentration | 4400 ppm |
| Pressure | 275 psig |
| Temperature | 225° C. (437° F.) |
| Amount of catalyst tested | 4 gm |
| GHSV (at P&T) | 2680 cm³_{gas}/cm³_{catalyst}/hr |
| Toluene flow rate | 0.05 mL/min |
| Flow rate of 4% O₂/N₂ | 179 sccm |
| Flow rate of 5% H₂S/N₂ | 95.7 sccm |
| Flow rate of pure N₂ | 2100 sccm |
| Predicted bed □P | 0.3 psi (8.3 in H₂O) |
| Run time | 31 hours |

Catalyst Tests with Added o-Xylene

TDA #2 catalyst was tested in the reactor system described above, for oxidizing 2000 ppm of H₂S into SO₂ using 3000 ppm of O₂ with 4100 ppm of o-xylene added to the feed. Xylene is known to be a coking precursor for Claus catalysts (Crevier et a. 2001). In any event, there was essentially no change in catalyst performance, nor was there any O₂ slip, when 4100 ppm of xylene was added to the feed with H₂S. The SO₂ yield remained above 90% with and without xylene. Furthermore, there was no deactivation apparent for the 25 hours that the xylene was flowing into the system. These results indicate that xylene is not detrimental to catalyst performance at concentrations at or below 4100 ppm, and in view of the results observed with 4400 ppm of toluene in the feed, BTX in concentrations near 1000 ppm (the value typically observed in the natural gas) should not adversely affect catalyst performance. Table 9 shows the experimental conditions used in the test with o-xylene. The conditions were identical to the previous toluene experiment except that 4100 ppm of o-xylene was present in the feed rather than 4400 ppm of toluene.

Prior to introducing xylene into the system, steady state H₂S oxidation was established over the catalyst (first 19 hr). During this initial 19 hr-period, the H₂S concentration was 2000 ppm and the oxygen concentration was 3000 ppm. The SO₂ selectivity was greater than 90% and the H₂S conversion was 99+%. The yield of SO₂ (SO₂ selectivity×H₂S conversion) was approximately 92% during this time. By difference, the selectivity to elemental sulfur was about 8%.

At 19 hours, the o-xylene flow was started at 0.05 mL/min. There was a brief drop off in SO₂ yield to approximately 89% but over the course of the next 10 hours the SO₂ yield increased back to >90%. The catalyst was not deactivated by the presence of 4100 ppm of xylene in the feed.

These results demonstrate that xylene present at more than 4 times the expected amount of BTEX concentration in natural gas, did will not adversely affect catalyst performance. These results indicate that the catalytic reaction of this invention will not be adversely affected by BTEX in natural gas feed streams.

TABLE 9
Experimental parameters for testing catalyst
with xylene in the feed.

| Parameter | Value |
|---|---|
| H₂S concentration | 2000 ppmv |
| O₂ concentration | 3000 ppmv |
| H₂O concentration | 0.95 psi |
| N₂ concentration | 98.7% |
| o-Xylene concentration | 4100 ppm |
| Pressure | 250 psig |
| Temperature | 225° C. (437° F.) |
| Amount of catalyst tested | 4 gm |
| GHSV (at P&T) | 2680 cm³_{gas}/cm³_{catalyst}/hr |
| o-Xylene flow rate | 0.048 mL/min |
| Flow rate of 4% O₂/N₂ | 179 sccm |
| Flow rate of 5% H₂S/N₂ | 95.7 sccm |
| Flow rate of pure N₂ | 2100 sccm |
| Predicted bed ΔP | 0.3 psi (8.3 in H₂O) |
| Run time | 45 hours |

BTEX does not function to deactivate the catalysts used in the inventive process. It is believed that the use of relatively low temperatures (ca 225° C.) substantially prevents the decomposition of aromatic hydrocarbons on the surface of the catalyst to form coke.

Test with Knockout Drum Condensate

Sensitivity of the catalyst to hydrocarbon contaminants, can be further tested using condensate from the knockout drum of a field site which will contain components that will be encountered in commercial applications of the process.

The apparatus of FIG. 11 is modified for introducing the vapors from the headspace of a sample of the knockout drum condensate from a gas plant by introduction of a condensate vaporizer (not shown). The condensate is essentially West Texas Crude oil and down-hole chemicals from an enhanced oil recovery using a CO₂ flood. The gas from the gas plant has a composition roughly the same as that given in Table 2 and the CO₂ concentration is large because this is the associated gas from the CO₂ flood.

The condensate vaporizer (operated at room temperature) is added to the test configuration as illustrated and N₂, H₂S and O₂ gases are passed through the headspace of this vaporizer to pick up VOCs (volatile organic components) given off by the condensate. The vaporizer employed is essentially a bubbler except that the gases do not bubble through the liquid but rather pass over the surface of the liquid to pick up volatile components in the liquid. This configuration is considered to better simulate the actual situation encountered with a KO drum in the field, and also prevents the entrainment of aerosol particles of liquid. In the field, a coalescing filter located upstream of the catalytic reactor will minimize or prevent entrainment of such aerosol particles.

KO Condensate Test 1

Table 10 shows the experimental conditions used in the test with KO condensate vapors. All of the experimental conditions were the same as in the xylene and toluene experiments, except that the space velocity was 2000 cm³_{gas}/cm³_{catalyst}/hr. The H₂S concentration was approximately 2000 ppm and the O₂/H₂S ratio was 1.5. The pressure was 285 psig and the catalyst temperature was 225° C. The concentration of volatiles in the KO condensate sample was estimated based on the properties of West Texas Crude Oil and was not measured directly. Two compositions for West Texas Crude: an intermediate and a sour crude are given in Table 11. To estimate the vapor pressure and the concentration of volatiles in the gas stream, the two composition of the crude oil were averaged, the dew point pressure of the averaged mixture was calculated for 70° F. (SuperTrapp, a vapor liquid equilibrium program developed at the National Institute of Standards and Technology. Heptane (C₇H₁₆) was used for the class saturates in the calculation.

TABLE 10
Experimental conditions during test with KO
condensate vapors.

| Parameter | Value |
|---|---|
| H₂S concentration | 2000 ppmv |
| O₂ concentration | 3000 ppmv |
| H₂O concentration | dry |
| N₂ concentration | 99.5% |
| KO vapor concentration | Estimated = 3400 ppm |
| Pressure | 275 psig |
| Temperature | 225° C. (437° F.) |
| Amount of catalyst tested | 4 gm |
| GHSV (at P&T) | 2000 cm³_{gas}/cm³_{catalyst}/hr |
| Flow rate of 4% O₂/N₂ | 107 sccm |
| Flow rate of 5% H₂S/N₂ | 95 sccm |
| Flow rate of pure N₂ | 1226 sccm |
| Predicted bed □P | 0.2 psi (8.3 in H₂O) |
| Run time | 50+ hours |

TABLE 11
Composition used to estimate vapor pressure if K.O drum condensate.

| | | | | Compound |
|---|---|---|---|---|
| | | | | used in |
| | | | | SuperTrapp |
| West Texas Crude | Intermediate | Sour | Averaged | Calc. |
| API Gravity | 40.8 | 30.2 | 35.5 | |
| Sulfur (wt %) | 0.48 | 1.5 | 0.99 | Ignored |
| Saturates (wt %) | 66 | 51 | 58.5 | Heptane |
| Aromatics (wt %) | 26 | 36 | 31 | Benzene |
| Resins (wt %) | 6 | 9 | | Ignored |
| Asphaltenes (wt %) | 1 | 5 | | Ignored |
| Waxes (wt %) | 4 | 5 | | Ignored |
| Benzene (ppm) | 1380 | 3510 | 0.002 | Benzene |
| Toluene (ppm) | 2860 | 6980 | 0.005 | Toluene |
| Ethylbenzene | 1120 | 5610 | 0.003 | Ethylbenzene |
| (ppm) | | | | |
| Xylenes (ppm) | 4290 | 4440 | 0.004 | Ortho-xylene |
| C3-benzenes (ppm) | 5920 | 7410 | 0.007 | Cumene |

The properties of the mixture at a dew point temperature of 70° F. (21° C., RT) calculated by SuperTrapp are shown in Table 12. The dew point pressure for the average mixture at 21° C. was calculated to be P=0.974 psia. Assuming this is the partial pressure of the condensate at room temperature, the total volatiles load in the feed gas was estimated to be about 3400 ppm (Table 10).

TABLE 12
Properties of K.O. condensate at a dew point
temperature of 70° F.

| Component | Feed | Liquid | Vapor |
|---|---|---|---|
| n-Heptane | 0.653478 | 0.843619 | 6.53E−01 |
| Benzene | 0.34631 | 0.155133 | 3.46E−01 |
| Toluene | 5.59E−05 | 8.69E−05 | 5.59E−05 |
| Ethylbenzene | 3.35E−05 | 1.53E−04 | 3.35E−05 |
| o-Xylene | 4.47E−05 | 2.66E−04 | 4.47E−05 |
| Isopropylbenzene (cumene) | 7.82E−05 | 7.42E−04 | 7.82E−05 |
| Molecular Weight | 92.5555 | 96.7948 | 92.5555 |
| Compressibility Factor | 0.993808 | 3.78E−04 | 0.993808 |
| Density (lb/ft³) | 1.60E−02 | 43.8864 | 1.60E−02 |
| Enthalpy (BTU/lb) | −439.619 | −811.685 | −439.619 |
| Entropy (BTU/lb*° F.) | 1.03011 | 7.53E−01 | 1.03011 |
| Heat Capacity (BTU/lb*° F.) | 0.354985 | 4.96E−01 | 0.354985 |
| Cp/Cv | | 1.29259 | 1.07E+00 |
| Sound Speed (ft/sec) | | 3770.19 | 547.541 |
| Joule-Thompson (° F./psia) | | −5.37E−03 | 0.800956 |
| Viscosity (lb/ft*sec) | | 2.88E−04 | 4.23E−06 |
| Thermal conductivity | | 0.07385 | 6.16E−03 |
| (BTU/ft*hr*F.) | | | |

TABLE 13
Concentration estimate.

| Property | Value |
|---|---|
| Dew point temperature | 70 |
| (° F.) | |
| Dew point pressure (psia) | 0.974 |
| Total Pressure (psia) | 287.2 |
| Concentration (ppm) | 3392 |

The first experiment was done using fresh (oxide form) catalyst. Initially, H₂S oxidation was performed with no KO vapors in the feed (for about 4 hours). During this control period, the H₂S conversion was 100%, and the selectivities to SO₂ and sulfur were S_{SO2}=91% and S_{S}=9%. At about 7.6 hours into the run, the total flow was diverted so that it passed over the KO condensate in the vaporizer shown in FIG. 12B. When the KO vapors were introduced, the SO₂ selectivity dropped to about 70% but then slowly returned to 100% over the next 35 hours.

KO Condensate Test 2

The slow recovery of SO₂ selectivity that was observed in KO test 1 could be explained as a slow depletion of volatiles from the KO sample. To assess this possibility, shorter length catalyst test runs using condensate from fresh KO were examined to better simulate the continuous gas processing situation that will be encountered in the field. The effect observed in test 1 of an initial drop in SO₂ selectivity followed by a gradual recovery was again observed. In a 7.5 hr experiment, the system was exposed to a gas stream containing KO condensate and allowed to come to steady state over one hour. At one hour H₂S conversion was complete (this corresponds to an H₂S concentration of less than about 5 ppm in the product gas) and the SO₂ selectivity was 71%. SO₂ selectively increased to approximately 83% by the end of the test. During this time the H₂S conversion remained at 100%. These results indicate that while the SO₂ selectivity depended on the presence of volatile organics in the feed, there was no catalyst deactivation due to these contaminants.

The observed changes in SO₂ selectivity indicate that catalyst selectivity is shifted by the presence of the most volatile components (likely to be BTEX aromatics) in the condensate because these will be the first to evaporate and their concentration is likely to be higher at the beginning of the run. A similar, but not as pronounced, drop in SO₂ selectivity followed by a gradual return to high SO₂ selectivity was observed in the experiments done using toluene and o-xylene. The effect observed in the earlier experiments was also not due to catalyst deactivation. All of the O₂ was consumed during test 2 with the KO condensate, and the gas flow rates, temperature and pressure were very stable.

In summary, the tests with toluene, xylene and vapors from the KO drum condensate indicate that the catalysts employed were not subject to deactivation by aromatic contaminants. The presence of volatile aromatics appears to affect SO₂ selectivity by shifting the selectivity to elemental sulfur. Little or no oxidation of the hydrocarbons occurs because all of the O₂ fed into the system can be accounted for by the combination of SO₂ and S, and because no unconverted H₂S was detected.

In a third test run using KO condensate (about 20 hrs, with fresh KO condensate), on exposure to gas containing KO condensate, a gradual increase in selectivity for SO₂ from approximately 84% up to essentially 100% was observed over the first 10 hours of the run. Because this is the same qualitative behavior observed in the two previous runs, the change in selectivity is believed due to evaporation and gradual loss of the more volatile components (which affect selectivity) from the KO drum.

The most important observation, however, is that the H₂S conversion was 100% during the entire experiment indicating that there was no catalyst deactivation due to the presence of the KO drum vapors.

Catalytic reactor temperatures were varied somewhat over the course of test 3 225° C. (for 8 hrs), 230° C. (for 4 hrs), 240° C. (4 hrs) and 250° C. (4 hrs). The increases in temperature had little effect on the conversion. In the 225-230° C. temperature range high selectivity to SO₂ with complete H₂S conversion was observed.

### Example 4

Desulfurization of Synthesis Gas

Desulfurization was performed on simulated gasification product gases using the direct oxidation method of this invention. The gas compositions tested are listed in Table 14 along with other test conditions. The simulated gasification product gas was introduced into the catalyst test system illustrated in FIG. 11. The catalyst employed was 5% iron oxide/0.5% molybdenum oxide/5% niobium oxide/titania, prepared as in Example 1.

The tests lasted approximately 16 hours during which time no unreacted H₂S appeared in the products (i.e. 100% H₂S conversion). In addition, the yield of elemental sulfur remained at about 90% and the SO₂ yield was about 10%. No catalyst deactivation was observed. The amount of oxygen introduced was just sufficient within experimental error to oxidize the amount of H₂S used and the amounts of sulfur and SO₂ that were observed. If any oxidation of H₂ or CO had occurred, then oxygen would have been consumed at the expense of either the sulfur yield or SO₂ yield and the H₂S conversion would have been lower. No evidence of oxidation of H₂ or CO was observed. The test results demonstrate that catalysts and methods of this invention can be used for desulfurization of gasification product gas streams, particularly gasification product gas and synthesis gas which contain at least 2 vol % of each of CO and hydrogen. The results also demonstrate that the catalysts and methods of this invention can be used to remove H₂S from gas streams containing about 5 vol % or more of each of CO and hydrogen. The results further demonstrate that the catalysts and methods of this invention can be used to remove H₂S from gas streams containing about 10 vol % or more of each of CO and hydrogen.

TABLE 14
Test Conditions for Desulfurization of Simulated
Product Gas from a Gasifier

| Test Condition | Test 1 | Test 2 |
|---|---|---|
| Hydrogen sulfide (H₂S) (ppm) | 2000 | 300 |
| Carbon monoxide (CO) (vol %) | 2 | 20 |
| Hydrogen (vol %) | 2 | 10 |
| Water vapor (vol %) | 3 | 6 |
| Oxygen (ppm) | 1300 | 150 |
| Nitrogen | Balance | Balance |
| Test pressure | 200 psig | 200 psig |
| Catalyst temperature | 179° C. | 179° C. |

### Example 5

Field Test Using Associated Gas from a Well Head—Removal of Hydrogen Sulfide and Mercaptans from Gas Streams

Associated gas from an oil field from which heavy hydrocarbons were removed by condensation (Table 15) was subjected to oxidation using an exemplary catalyst of this invention 0.5% MoO₃/5% Nb₂O₅/TiO₂ prepared by co-forming as described in Example 1.

TABLE 15
Typical inlet and outlet gas compositions during 1000
hour field test.

| | Inlet | Outlet | |
|---|---|---|---|
| Component | Concentration | Concentration | Units |
| Hydrogen sulfide (H₂S) | 8000 | 950 | ppm |
| Nitrogen (N₂) | 1.6 | 2.9 | vol % |
| Methane (CH₄) | 17.7 | 17.8 | vol % |
| Carbon Dioxide (CO₂) | 58.6 | 58.7 | vol % |
| Ethane | 8.7 | 8.6 | vol % |
| Propane | 6.5 | 6.3 | vol % |
| Butanes | 9.8 | 9.5 | vol % |
| Pentanes & Hexanes | 2.2 | 2.1 | vol % |
| Heptane through Nonane | 0.16 | 0.11 | vol % |
| BTEX (aromatics) | 0.24 | 0.19 | vol % |
| Mercaptans (thiols) | 101 | 20 | ppm |

The test employed a fixed bed reactor as illustrated in FIG. 11 operated at temperatures between about 170-200° C. After analysis, outlet gas was flared. The catalyst was formed into ⅛ inch extrudate with a surface area between about 90-100 m²/g. Approximately 288,000 (standard cubic feet/day) SCFD of gas were processed. Inlet and outlet concentrations of gas components are listed in Table 15. Sulfur dioxide (SO₂) levels of 20 ppm were measured at the outlet. Conversion of H₂S was about 88% and 99.8% of that H₂S was converted into sulfur. The yield of sulfur was thus 87.8% and the overall product rate was about 200-250 lb/day.

The associated gas also contained mercaptans (organic sulfur compounds with the generic formula R—SH, where R is an alky group). The level of mercaptans in the gas stream was also significantly decreased (by about 80%) on treatment using the process of this invention.

Those of ordinary skill in the art will appreciate that methods and known in the art and can be applied or readily adapted to the practice of this invention without resort to undue experimentation. For example, methods for synthesis of mixed metal oxides other than those specifically exemplified are known in the art and can be applied to the preparation of catalysts. All art-known equivalents of materials, methods specifically exemplified herein are intended to be encompassed by this invention. All references cited herein are incorporated by reference herein to the extent that they are not inconsistent with the disclosure herein.

REFERENCES

Alcoa (1997) “Look at Claus Unit Design,” Alcoa Technical Bulletin 6030-R010797.

Butt, J. B. and Petersen, E. E.(1988) Activation, Deactivation and Poisoning of Catalysts, Academic Press, p. 83

Crevier, P. P., Dowling, N. I., Clark, P. D. and Huang, M. (2001) “Quantifying the Effect of Individual Aromatic Contaminants on Claus Catalyst,” Proceedings, 51^{st} Annual Laurance Reid Gas Conditioning Conference, University of Oklahoma, February 2001.

Fisher, K. S., J. E. Lundeen, D. Leppin (1999) “Fundamentals of H₂S Scavenging for Treatment of Natural Gas,” Ninth GRI Sulfur Recovery Conference Oct. 24-27, 1999, San Antonio Tex.

“Gas Processes 2002” in Hydrocarbon Processing, May 2002, pp.107-121.

Goar, B. G., and Sames, J. A., (1983). “Tail Gas Clean-up Processes—A Review,” Proceedings: Gas Conditioning Conference 1983, March, p. E-13.

Hardison, L. C. and Ramshaw, D. E. “H₂S to S: Process Improvements,” Hydrocarbon Processing, Vol. 71, January 1992, pp. 89-90.

Janssen, A. J. H. et al. (2001) “Biological Process for H₂S Removal from High-Pressure Gas: the Shell-Paque/THIOPAQ Gas Desulfurization Process,” Sulphur.

Kohl, A. and Nielsen, R. (1997) Gas Purification, 5^{th} ed., Gulf Publishing Company.

Marshneva, V. I., and V. V. Mokrinskii (1989). “Catalytic Activity of Metal Oxides in Hydrogen Sulfide Oxidation by Oxygen and Sulfur Dioxide,” Kinetics and Catalysis, 29(4), pp. 989-993.

McIntush, K. E.; Petrinec, B. J.; Beitler, C. A. M. (2000) “Results of Pilot Testing the CrystaSulf^{SM} Process,” Proceedings of the 50^{th} Laurance Reid Gas Conditioning Conference, Feb. 27-Mar. 1, 2000, Norman Okla.

McIntush, K. E. C. O. Rueter and K. E. De Berry (2001) “Comparison of Technologies for Removing Sulfure for High-Pressure Sour Natural Gas with Sulfur Throughputs between ).1 and 30 Long Tons/Day,” Proc. 80^{TH} Annual GPA Convention.

Mirzoev, I. M (1991) “Oxidation of Hydrogen Sulfide on a Multicomponent Iron-Containing Catalyst. Journal of applied chemistry of the USSR. Feburary 1 v 64 n 2 p 1, p. 238.

Nagl, G. J. (1991) “The State of Liquid Redox” Proceedings of the Ninth Gas Research Institute Sulfur Recovery Conference, Gas Research Institute Chicago, Ill.

Nagl, G. J. (2001) “Employing Liquid Redox as a tail Gas Cleanup Unit” 2001 NPRA Environmental Conference Sep. 23-25, 2001, Austin Tex., National Petrochemical and Refiners Association, Washington, D.C.

Nivak, M. and Zdrazil, M. (1991) “Oxidation of Hydrogen Sulfide over Fe₂O₃/Al₂O₃ Catalyst: Influence of Support Texture and Fe₂O₃ Precursor”. Collection of Czechoslovak Chemical Communication Sep. 1, v 56 n 9, p. 1893.

Olah, G. A. and Molnar, A. (1995) Hydrocarbon Chemistry, Wiley.

Oostwouder, S. P. (1997) “SulFerox Process Update,” Proc. GRI Sulfur Recovery Conf. 8^{th} Meeting, 1997.

Pacific Environmental Services (1996) Background Report AP-42 Section 5.18 “Sulfur Recovery” Prepared for the United States Environmental Agency OAQPS/TSD/EIB available from the US EPA (Pacific Environmental Services, Inc. P.O. Box 12077 Research Triangle Park, N.C. 27709).

Satterfield, C. N. (1991) Heterogeneous Catalysis in Industrial Practice, 2^{nd} ed., McGraw-Hill.

Smit, C. J. and E. C. Heyman (1999) “Present Status SulFerox Process.” Proc. GRI Sulfur Recovery Conf. 9^{th} Meeting, 1999.

Stocchi, E. (1990) Industrial Chemistry, Ellis Norwood, p. 203.

We claim:

1. A method for selectively oxidizing hydrogen sulfide to sulfur dioxide, sulfur or mixtures thereof in a gas stream containing oxidizable components other than hydrogen sulfide which comprises the step of:
a. contacting the gas stream containing hydrogen sulfide and other oxidizable components with a mixed metal oxide catalyst at a temperature equal to or less than about 400° C. in the presence of oxygen;
wherein the mixed metal oxide catalyst comprises a low oxidation activity metal oxide and one or more higher oxidation activity metal oxides such that a substantial amount of the hydrogen sulfide present in the gas stream is oxidized to sulfur dioxide, sulfur or a mixture thereof and wherein less than about 25% by volume of the oxidizable components except sulfur containing compounds are oxidized by the added oxygen.

2. The method of claim 1 wherein the low oxidation activity metal oxide is titania, silica, alumina or mixtures thereof.

3. The method of claim 1 wherein less than about 10% by volume of the oxidizable components except sulfur containing compounds are oxidized.

4. The method of claim 1 wherein less than about 1% by volume of the oxidizable components except sulfur containing compounds are oxidized

5. The method of claim 1 wherein the oxidizable components other than hydrogen sulfide are selected from hydrocarbons, oxygenated hydrocarbons, sulfur-containing hydrocarbons, aromatic hydrocarbons, aliphatic hydrocarbons, hydrogen, carbon monoxide or mixtures thereof.

6. The method of claim 1 wherein the oxidizable components other than hydrogen sulfide are selected from hydrogen, carbon monoxide or mixtures thereof.

7. The method of claim 1 wherein the oxidizable components other than hydrogen sulfide are hydrocarbons, oxygenated hydrocarbons, or mixtures thereof.

8. The method of claim 1 wherein the oxidizable components other than hydrogen sulfide are aliphatic hydrocarbons.

9. The method of claim 8 wherein the aliphatic hydrocarbons comprise methane, ethane, propane, butane, pentane, hexane or mixtures thereof.

10. The method of claim 8 wherein the aliphatic hydrocarbon is methane.

11. The method of claim 1 wherein the oxidizable components other than hydrogen sulfide are aromatic hydrocarbons.

12. The method of claim 1 wherein the oxidizable components are benzene, toluene, ethylbenzene and xylene.

13. The method of claim 1 wherein the oxidizable component is CO.

14. The method of claim 13 wherein the CO is present in the gas stream at a level of 30% by volume of CO or more.

15. The method of claim 13 wherein the CO is present in the gas stream at a level of 10% by volume of CO or more.

16. The method of claim 13 wherein the CO is present in the gas stream at a level of 1% by volume to about 10% by volume.

17. The method of claim 1 wherein the gas stream is substantially hydrocarbons, oxygenated hydrocarbons or sulfur containing hydrocarbons.

18. The method of claim 1 wherein the gas stream comprises 1% or less by volume of benzene, toluene, ethylbenzene or xylene.

19. The method of claim 1 wherein the gas stream is substantially methane.

20. The method of claim 1 wherein the temperature at which the catalyst is contacted with the gas stream in the presence of oxygen at a temperature less than 400° C.

21. The method of claim 20 wherein the temperature is between about 160° C. and about 250° C.

22. The method of claim 20 herein the temperature is between about 170° C. and about 200° C.

23. The method of claim 1 wherein oxygen is present in the gas stream such that the ratio of O₂/H₂S therein ranges from about 0.4 to about 1.75.

24. The method of claim 1 wherein oxygen is present in the gas stream such that the ratio of O₂/H₂S therein is 0.4 or more.

25. The method of claim 24 wherein the ratio of O₂/H₂S in the gas stream ranges from 0.5 to 1.5.

26. The method of claim 24 wherein the ratio of O₂/H₂S in the gas stream is greater than about 1.5

27. The method of claim 24 wherein the ratio of O₂/H₂S in the gas stream is 1.0 or less.

28. The method of claim 24 wherein the ratio of O₂/H₂S in the gas stream is 1 or greater.

29. The method of claim 1 wherein 99% by volume or more of the hydrogen sulfide in the gas stream is converted to sulfur dioxide, sulfur or mixtures thereof.

30. The method of claim 1 wherein 95% by volume or more of the hydrogen sulfide in the gas stream is converted to sulfur dioxide, sulfur or mixtures thereof.

31. The method of claim 1 wherein 85% by volume or more of the hydrogen sulfide in the gas stream is converted to sulfur dioxide, sulfur or mixtures thereof.

32. The method of claim 1 wherein the hydrogen sulfide in the gas stream is converted substantially to sulfur dioxide.

33. The method of claim 1 wherein the ratio of hydrogen sulfide to sulfur dioxide in the gas stream after oxidation ranges from about 1:1 to about 3:1.

34. The method of claim 1 wherein the hydrogen sulfide in the gas stream is converted substantially to sulfur.

35. The method of claim 1 wherein the gas stream after oxidation comprises hydrogen sulfide and sulfur dioxide in the ratio of about 2 to 1

36. The method of claim 1 wherein the lower oxidation activity metal oxide is titania or a mixture of titania with silica.

37. The method of claim 1 wherein the lower oxidation activity metal oxide is titania.

38. The method of claims 1 wherein the lower oxidation activity metal oxide is an alumina.

39. The method of claim 38 wherein the alumina is alpha alumina or gamma alumina.

40. The method of claim 1 wherein the lower oxidation activity metal oxide is selected from titania, silica, alumina or mixtures thereof and the higher activity metal oxide is selected from an oxide of a metal selected from the group V, Cr, Mn, Fe, Co, Ni, Cu, Nb, Mo, Tc, Ru, Rh, Hf, Ta, W, Au, La, Ce, Pr, Nd, Pm, Eu, Gd, Tb, Dy, Ho, Er, Tm, Yb, Lu and mixtures thereof.

41. The method of claim 40 wherein the higher oxidation activity metal oxide is selected from a metal oxide of a metal selected from the group consisting of Fe, Co, Mn, Cr, Cu, Mo, Nb, or mixtures thereof.

42. The method of claim 40 wherein the higher oxidation activity metal oxide is a metal oxide of a transition metal or a mixture of transition metals.

43. The method of claim 40 wherein the mixed metal oxide catalyst comprises one or more metal oxides of lanthanide metals.

44. The method of claim 1 wherein the low oxidation activity metal oxide is titania.

45. The method of claim 1 wherein the mixed metal oxide catalyst comprises titania, silica, alumina or mixtures thereof in combination with one or more metal oxides of a metal selected from Fe, Co, Mn, Cr, Cu, Mo, Nb and mixtures thereof.

46. The method of claim 45 wherein the mixed metal oxide catalyst comprises titania, silica, alumina or mixtures thereof in combination with two or more metal oxides of a metal selected from Fe, Co, Mn, Cr, Cu, Mo and Nb.

47. The method of claim 45 wherein the mixed metal oxide catalyst comprises titania, silica, alumina, or mixtures thereof in combination with three or more metal oxides of a metal selected from Fe, Co, Mn, Cr, Cu, Mo and Nb.

48. The method of claim 45 wherein the mixed metal oxide catalyst comprises titania, silica, alumina or mixtures thereof in combination with a metal oxide of Mo, Nb or both and in combination with a metal oxide selected from Fe, Co, Mn, Cr, and Cu.

49. The method of claim 45 wherein the mixed metal oxide catalyst comprises titania, an oxide of Mo, an oxide of Nb and an oxide of one or more of Fe, Co, Cr, Mn and Cu.

50. The method of claim 49 wherein the metal oxide catalyst comprises titania, an oxide of Mo, an oxide of Nb and an oxide of Cu or Fe.

51. The method of claim 1 wherein titania or a combination of titania and silica is present at a level of 50% by weight or more in the catalyst.

52. The method of claim 51 wherein titania or a combination of titania and silica is present at a level of 85% by weight or more in the catalyst.

53. The method of claim 51 wherein the metal oxide catalyst contains from about 0.1% to about 10% by weight of each of one, two, three or four metal oxides wherein the metal oxide is a metal oxide wherein the metal is selected from Fe, Co, Mn, Cr, Cu, Mo and Nb.

54. The method of claim 1 wherein the metal oxide catalyst contains from 0.1% to about 10% by weight of oxide of Mo, an oxide of Nb or both and contains from about 1% to about 10% by weight of an oxide of Fe, Cu or Co.

55. The method of claim 1 wherein the catalyst comprises about 1 to 10% by weight copper oxide, about 1 to 10% by weight niobium oxide, 0.1 to 1% by weight molybdenum oxide with the remainder being titania or a mixture of titania and silica.

56. The method of claim 1 wherein the catalyst comprises about 1 to 10% by weight Iron oxide, about 1 to 10% by weight niobium oxide, 0.1 to 1% by weight molybdenum oxide with the remainder being titania or a mixture of titania and silica.

57. The method of claim 1 wherein the catalyst comprises about 1 to 10% by weight cobalt oxide, about 1 to 10% by weight niobium oxide, 0.1 to 1% by weight molybdenum oxide with the remainder being titania or a mixture of titania and silica.

58. The method of claim 1 wherein the mixed metal oxide catalyst comprises about 0.4 to 0.6% by weight molybdenum oxide, about 4 to 6% by weight niobium oxide, about 4 to 6% by weight of copper oxide, cobalt oxide, iron oxide, or a mixture thereof with the remainder being titania or a mixture of titania and silica.

59. The method of claim 1 wherein the mixed metal oxide catalyst comprises up to about 10% by weight of a binder.

60. The method of claim 59 wherein the binder is silica.

61. The method of claim 1 wherein the mixed metal oxide catalyst comprises titania in combination with one or more mixed metal oxides wherein the metal is selected from Fe, Cu, Co, Mo, Nb, Mn and Cr and wherein the temperature at which step a is conducted ranges between about 160° C. to about 250° C.

62. The method of claim 61 wherein the amount of oxygen in the gas stream is such that the ratio of O₂/H₂S is about 0.4 to about 1.75.

63. The method of claim 62 wherein the amount of oxygen in the gas stream is such that the ratio of O₂/H₂S is about 1:1.

64. The method of claim 1 wherein the catalyst is co-formed.

65. The method of claim 1 wherein the catalyst is formed into pellets or is extruded.

66. The method of claim 1 wherein the catalyst has a surface area ranging from about 50 to about 150 m²/g.

67. The method of claim 1 wherein the catalyst is sulfated on contact with hydrogen sulfide, sulfur dioxide or sulfur.

68. The method of claim 1 wherein the catalyst is prepared by calcining a mixed metal oxide powder at a temperature of about 300° C. to 550° C.

69. The method of claim 1 wherein the catalyst is prepared by calcining a mixed metal oxide powder at a temperature of about 400° C. to 450° C.

70. The method of claim 1 wherein the mixed metal oxide catalyst is prepared by co-forming.

71. The method of claim 1 wherein the gas stream also contains water vapor.

72. The method of claim 1 wherein the gas stream also contains CO₂.

73. A method for removing hydrogen sulfide from a feed gas stream containing other oxidizable components which comprises the steps of
a. selectively oxidizing hydrogen sulfide in the feed gas stream using the method of claim 1 to generate sulfur, SO₂ or both in a product gas stream
b. optionally removing at least a portion of sulfur, sulfur dioxide or both in the product gas stream; and
c. optionally returning the product gas stream from which sulfur, SO₂ or both have been removed to step a, if necessary, to generate additional sulfur, sulfur dioxide or both and repeating step b and c until the undesired hydrogen sulfide is removed from the gas stream.

74. The method of claim 73 wherein the metal oxide catalyst comprises titania or a mixture of titania and silica in combination with an oxide of Fe, Co or Cu, a metal oxide of Mo, and a metal oxide of Nb.

75. The method of claim 73 where in step a the temperature of operation, catalyst and the O₂/H₂S ratio in the feed gas stream are selected to generate a product gas stream which by itself or when blended with the feed gas stream generates a product gas stream in which the H₂S/SO₂ ratio is about 2 to 1 and further comprising the step of treating the product gas stream by liquid phase Claus sulfur recovery process in which SO₂ and H₂S are reacted to form sulfur and water.

76. The method of claim 75 wherein sulfur is condensed and removed from the product stream prior to blending with the feed gas stream or prior to treatment of the product gas stream by the liquid phase Claus process.

77. The method of claim 73 where in step a the temperature of operation, catalyst and the O₂/H₂S ratio in the feed gas stream are selected to generate a product gas stream in which sulfur generated by H₂S oxidation is maximized and SO₂ generated by H₂S oxidation is minimized and in which sulfur is removed from the product gas stream and which further comprises the step of treating the product gas stream with a liquid redox process for removal of remaining H₂S.

78. The method of claim 73 where in step a the temperature of operation, catalyst and the O₂/H₂S ratio in the feed gas stream are selected to generate a product gas stream in which sulfur generated by H₂S oxidation is maximized and SO₂ generated by H₂S oxidation is minimized and in which sulfur is removed from the product gas stream and which further comprises the step of treating the product gas stream with a biological sulfur removal process for removal of remaining H₂S.

79. The method of claim 73 where in step a the temperature of operation, catalyst and the O₂/H₂S ratio in the feed gas stream are selected to generate a product gas stream in which sulfur generated by H₂S oxidation is maximized and SO₂ generated by H₂S oxidation is minimized and in which sulfur is removed from the product gas stream and which further comprises the step of treating the product gas stream with a scavenger process for removal of remaining H₂S.

80. The process of claim 73 wherein in step a the temperature of operation, catalyst and the O₂/H₂S ratio in the feed gas stream are selected to generate a product gas stream in which sulfur generated by H₂S oxidation is maximized and SO₂ generated by H₂S oxidation is minimized and in which sulfur is removed from the product gas stream and which further comprises the step of treating the product gas stream in an amine separation unit to separate H₂S, SO₂ or both from the product gas to generate a feed gas stream containing H₂S, SO₂ or both which is thereafter returned to step a.

81. The process of claim 73 wherein the feed gas stream is a natural gas stream containing H₂S.

82. The method of claim 73 wherein the metal oxide catalyst comprises titania or a mixture of titania and silica in combination with an oxide of Fe, Co or Cu, a metal oxide of Mo, and a metal oxide of Nb.

83. A method for desulfurization of a gas stream containing carbon monoxide and hydrogen which comprises the step of
a. contacting the gas stream with a mixed metal oxide catalyst at a temperature equal to or less than about 400° C. in the presence of a selected amount of oxygen;
wherein the mixed metal oxide catalyst comprises a low oxidation activity metal oxide and one or more higher oxidation activity metal oxides such that a substantial amount of the hydrogen sulfide present in the gas stream is oxidized to sulfur dioxide, sulfur or a mixture thereof and wherein less than about 10% by volume of the carbon monoxide and hydrogen are oxidized.

84. The method of claim 83 wherein the low oxidation activity metal oxide is selected from titania, silica, alumina or a mixture thereof.

85. The method of claim 83 wherein the higher oxidation activity metal oxide is selected from a metal oxide in which the metal is selected from V, Cr, Mn, Fe, Co, Ni, Cu, Nb, Mo, Tc, Ru, Rh, Hf, Ta, W, Au, La, Ce, Pr, Nd, Pm, Eu, Gd, Th, Dy, Ho, Er, Tm, Yb, Lu and mixtures thereof.

86. The method of claim 83 wherein the higher oxidation activity metal oxide is selected from a metal oxide in which the metal is selected from Fe, Co, Cr, Cu, Mo, Nb and mixtures thereof.

87. The method of claim 83 wherein the mixed metal oxide catalyst comprises titania, alumina, silica or mixtures thereof in combination with one or more metal oxides in which the metal is Fe, Co, Cr, Cu, Mo, Nb and mixtures thereof.

88. The method of claim 83 wherein the mixed metal oxide catalyst comprises about 0.1% to about 1% by weight of an oxide of Mo, about 1% to about 10% by weight of an oxide of Nb and optionally from about 1% to about 10% by weight of an oxide of Fe, Cu, Co or mixtures thereof.

89. The method of claim 83 wherein the remainder of the mixed metal oxide catalyst is titania or a mixture of titania and silica.

90. The method of claim 83 wherein the mixed metal oxide catalyst comprises titania in combination with about 0.5 to 1% by weight molybdenum oxide, and about 4 to 6% by weight niobium oxide.

91. The method of claim 83 wherein the mixed metal oxide catalyst comprises titania in combination with about 0.5 to 1% by weight molybdenum oxide, and about 5% by weight niobium oxide.

92. The method of claim 83 wherein step a is conducted at a temperature between about 100° C. and about 400° C.

93. The method of claim 83 wherein step a is conducted at a temperature of about 200° C.

94. The method of claim 83 wherein H₂S is oxidized into elemental sulfur, sulfur dioxide (SO₂) or both.

95. The method of claim 83 wherein the space velocity of step a is between about 500 and 20,000 m³ of gas/m³ of catalyst/hour.

96. The method of claim 83 wherein step a is conducted at ambient pressure.

97. The method of claim 83 wherein step a is conducted at a pressure above ambient up to about 1000 psig.

98. A catalytic reactor system for selectively oxidizing hydrogen sulfide in a gas stream containing hydrogen sulfide to sulfur dioxide, sulfur or mixtures thereof which comprises:
a catalytic reactor containing a mixed metal oxide catalyst in which an entering gas stream containing hydrogen sulfide and an oxygen-containing gas are contacted with the catalyst,
a sulfur condenser for removing sulfur produced in the catalytic reaction from the gas stream to generate a gas stream with decreased levels of hydrogen sulfide; and
a outlet for exiting the treated gas stream for release of the gas stream with decreased levels of hydrogen sulfide from the system or for passage of the exiting gas stream with decreased levels of hydrogen sulfide to downstream processing;
wherein the mixed metal oxide catalyst comprises a low oxidation activity metal oxide and one or more higher oxidation activity metal oxides such that a substantial amount of the hydrogen sulfide present in the gas stream is oxidized to sulfur dioxide, sulfur or a mixture thereof, wherein the entering gas stream contains oxidizable components other than sulfur containing compounds and wherein less than about 25% by volume of the oxidizable components except sulfur containing compounds in the entering gas stream are oxidized by the added oxygen.

99. The catalytic reactor system of claim 98 wherein the catalytic reactor is operated at a temperature less than or equal to 400° C.

100. The catalytic reactor system of claim 98 wherein the catalytic reactor is operated at a temperature between about 160° C. and about 250° C.

101. The catalytic reactor system of claim 98 wherein the downstream processing is selected from the groups consisting of:
treating the exiting gas stream with scavenging chemicals;
passing the exiting gas stream into a liquid phase redox sulfur removal system;
passing the exiting gas stream into a tail gas treatment system;
passing the exiting gas stream into a liquid Claus sulfur removal system; or
passing the exiting gas stream into a Claus reactor.

102. The catalytic reactor of claim 101 wherein the gas stream after downstream processing contains 4 ppmv of hydrogen sulfide or less.

103. The catalytic reactor of claim 98 further comprising an entering gas stream bypass for directing a portion of the entering gas stream directly to downstream processing.

104. The catalytic reactor of claim 98 further comprising a recycling system for directing at least a portion of the gas stream exiting the catalytic reactor, the gas stream exiting downstream processing or both into the entering gas stream.

105. The catalytic reactor of claim 98 further comprising a recycling system for directing at least a portion of the gas stream exiting downstream processing into the gas stream exiting the catalytic reactor for another passage through downstream processing.

106. The catalytic reactor of claim 98 wherein the entering gas stream is a natural gas stream or a synthesis gas stream.
